(19) United States
(12) Patent Application Publication
(10) Pub. No.: US 2003/0158735 A1
(43) Pub. Date: Aug. 21, 2003

(54) Information processing apparatus and method with speech synthesis function

(75) Inventors: Masayuki Yamada, Kanagawa (JP); Katsuhiko Kawasaki, Kanagawa (JP); Toshiaki Fukada, Kanagawa (JP); Yasuo Okutani, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/361,612

(22) Filed: Feb. 11, 2003

(30) Foreign Application Priority Data
Feb. 15, 2002 (JP) 2002-039033
Apr. 25, 2002 (JP) 2002-124368

(51) Int. Cl. G10L 13/08

(52) U.S. Cl. 704/260

(57) ABSTRACT

With this invention, an information processing apparatus which has an audio data playback function and text-to-speech synthesis function allows the user to input an instruction by a fewer operations and provides a fast-forward/fast-reverse function optimal to speech synthesis. During speech synthesis, an instruction input by a button operation is supplied to a speech synthesis unit. When playback of audio data is underway, but speech synthesis is inactive, an instruction input by a button operation is supplied to an audio data playback unit. In a fast-forward mode, an abstract is read aloud or head parts of sentences are read aloud. In a fast-reverse mode, head parts of sentences are read aloud. Also, given tones are generated in correspondence with skipped parts.

### FIELD OF THE INVENTION

The present invention relates to an information processing apparatus and method with a speech synthesis function.

### BACKGROUND OF THE INVENTION

Nowadays, a portable information terminal like the one shown in FIG. 20 is commercially available, and various information processes are executed using this information terminal. This portable information terminal comprises, e.g., a communication unit, storage unit, speech output unit, and speech synthesis unit, which implement the following “recorded audio data playback”, “stored document reading”, and “new arrival information reading” functions, and the like.

1) “Recorded audio data playback” function

Audio data such as music, a language learning material, and the like, which are downloaded via the communication unit are stored in the storage unit, and are played back at an arbitrary timing and place.

2) “Stored Document reading” function

Text data such as a novel or the like stored in a data storage unit is read aloud using speech synthesis (text-to-speech conversion) to browse information everywhere.

3) “New arrival information reading” function

Connection is established to the Internet or the like using the communication unit to acquire real-time information (text data) such as mail messages, news articles, and the like. Furthermore, the obtained information is read aloud using speech synthesis (text-to-speech conversion).

Furthermore, the following functions that combine the “recorded audio data playback”, “stored document reading”, and “new arrival information reading” functions is available.

4) “Document reading using recorded audio data as BGM” function

A stored document or new arrival information (text data) is read aloud using speech synthesis (text-to-speech conversion) while playing back recorded audio data.

5) “New arrival information interrupt message” function

Upon arrival of a mail message or new arrival news article, it is read aloud using speech synthesis (text-to-speech conversion). Since speech is used, it hardly disturbs other works. Also, synthetic speech can be superimposed on, e.g., played back music.

However, the aforementioned conventional method suffers the following two problems.

The first problem is an increase in the number of operation buttons.

The user can make operations “playback”, “stop”, “fast-forward”, and “fast-reverse” during execution of the “recorded audio data playback”, “stored document reading”, and “new arrival information reading” functions. However, operation buttons such as “playback”, “stop”, “fast-forward”, “fast-reverse”, and the like are independently provided to those of the “recorded audio data playback”, “stored document reading”, and “new arrival information reading” functions, the number of components increases, and such buttons occupy a large space. As a result, the size of the overall information terminal increases, and the manufacturing cost rises.

The second problem is as follows. That is, when a “fast-forward” or “fast-reverse” process as in playback of recorded audio data is executed while reading aloud text using speech synthesis (text-to-speech conversion), the user cannot catch the contents read aloud using speech synthesis (text-to-speech conversion) during the “fast-forward” or “fast-reverse” process, resulting in poor convenience.

Also, digital documents obtained by converting the contents of printed books into digital data increase year by year. As digital documents increases, a device for browsing such data like a book (so-called e-book device), and a text-to-speech reading apparatus or software program that reads a digital document aloud using speech synthesis are commercially available. A given text-to-speech reading apparatus or software program has a bookmark function which stores the previous reading end position, and restarts reading while going back a given amount from the position (bookmark position) of text upon stopping reading. This function allows the user to easily bring association with the previously read sentences to mind, and helps him or her understand the contents of sentences.

However, the conventional text-to-speech reading apparatus or software uses a constant return amount of the reading start position upon restarting reading. For this reason, if that return amount is too short, such function cannot help the user understand the contents of actual sentences. On the other hand, if the return amount is too long, the user can bring the previously read sentences to mind, but it is often redundant. That is, since a constant return amount is used, it rarely helps the user understand the contents of actual sentences.

### SUMMARY OF THE INVENTION

The present invention has been made to solve the conventional problems, and has as its object to provide a portable information processing apparatus and an information processing method, which allow various operations such as “playback”, “stop”, “fast-forward”, “fast-reverse”, and the like during “recorded audio data playback”, “stored document reading”, and “new arrival information reading” operations, and can prevent an increase in manufacturing cost due to an increase in the number of components such as operation buttons.

It is another object of the present invention to provide a convenient, portable information processing apparatus and an information processing method, which allow the user to catch the contents read aloud using speech synthesis even when a “fast-forward” or “fast-reverse” process as in playback of recorded audio data is executed while reading aloud text using speech synthesis (text-to-speech conversion).

It is still another object of the present invention to provide a text-to-speech reading apparatus, its control method, and a program, which have an adjustment function that can return a reading restart position to a position, which is necessary and sufficient to allow the user to bring association of previously read sentences to mind, upon restarting reading after it is stopped.

According to the present invention, the foregoing object is attained by providing an information processing apparatus comprising; playback means for playing back audio data; speech synthesis means for converting text data into synthetic speech, and outputting the synthetic speech; instruction detection means for detecting a user's instruction; detection means for detecting operation states of the playback means and the speech synthesis means; instruction supply means for supplying the user's instruction to one of the playback means and the speech synthesis means in accordance with the operation states; and control means for controlling the playback means or the speech synthesis means that has received the user's instruction to execute a process based on the user's instruction.

According to another aspect of the present invention, the foregoing object is attained by providing an information processing apparatus comprising; speech synthesis means for converting text data into synthetic speech, and outputting the synthetic speech; input means used to input a user's instruction; status detection means for detecting a state of the input means; and control means for controlling the speech synthesis means to output synthetic speech of the text data in a fast-forward mode or a fast-reverse mode in accordance with the detected state of the input means.

In still another aspect of the present invention, the foregoing object is attained by providing an information processing apparatus comprising; speech synthesis means for converting text data into synthetic speech, and outputting the synthetic speech; instruction detection means for detecting a user's instruction; detection means for detecting an operation state of the speech synthesis means; instruction supply means for supplying the user's instruction to the speech synthesis means in accordance with the operation state; and control means for controlling the speech synthesis means that has received the user's instruction to execute a process based on the user's instruction.

In still another aspect of the present invention, the foregoing object is attained by providing a text-to-speech reading apparatus for implementing text-to-speech reading using speech synthesis, comprising; control means for controlling start/stop of text-to-speech reading of text; and measurement means for measuring a time period between reading stop and restart timings, wherein the control means controls a reading restart position of the text upon restarting the text-to-speech reading in accordance with the measured time period.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principle of the invention.

FIG. 1 is a block diagram showing the hardware arrangement of an information terminal according to the first embodiment of the present invention;

FIG. 2 is a flow chart for explaining a whole event process according to the first embodiment of the present invention;

FIG. 3 is a flow chart for explaining a process executed upon depression of a playback button;

FIG. 4 is a flow chart for explaining a process executed upon depression of a stop button;

FIG. 5 is a flow chart for explaining a process executed upon depression of a pause button;

FIG. 6 is a flow chart for explaining a process executed upon depression of a fast-forward button;

FIG. 7 is a flow chart for explaining a process executed upon release of the fast-forward button;

FIG. 8 is a flow chart for explaining a process executed upon depression of a fast-reverse button;

FIG. 9 is a flow chart for explaining a process executed upon release of the fast-reverse button;

FIG. 10 is a flow chart for explaining a process executed upon arrival of new information;

FIG. 11 is a flow chart for explaining a process executed upon reception of a stored information text-to-speech conversion instruction;

FIG. 12 is a flow chart for explaining a process executed upon reception of a speech synthesis instruction;

FIG. 13 is a flow chart for explaining a process executed upon reception of a recorded audio playback instruction;

FIG. 14 is a flow chart for explaining a timer event process;

FIG. 15A is a flow chart for explaining a speech synthesis start process;

FIG. 15B is a flow chart for explaining a speech synthesis stop process;

FIG. 15C is a flow chart for explaining a speech synthesis pause process;

FIG. 15D is a flow chart for explaining a speech synthesis restart process;

FIG. 16A is a flow chart for explaining a recorded audio data playback start process;

FIG. 16B is a flow chart for explaining a recorded audio data playback stop process;

FIG. 16C is a flow chart for explaining a recorded audio data playback pause process;

FIG. 16D is a flow chart for explaining a recorded audio data playback restart process;

FIG. 17 is a view for explaining an example of a new arrival notification message;

FIGS. 18A and 18B are views for explaining an image of a first word list;

FIGS. 19A and 19B are views for explaining an image of an abstract;

FIG. 20 shows an outer appearance of the information terminal according to the first embodiment of the present invention;

FIG. 21 is a block diagram showing the hardware arrangement of an information terminal according to the second embodiment of the present invention;

FIG. 22 is a flow chart for explaining a whole event process according to the second embodiment of the present invention;

FIG. 23 is a flow chart for explaining a process executed when a dial angle has been changed;

FIG. 24 is a flow chart for explaining a process executed upon reception of a speech synthesis request;

FIG. 25 is a table for explaining correspondence between the dial angle and reading skip count;

FIG. 26 is a view for explaining an example of synchronous points;

FIG. 27 shows an outer appearance of the information terminal according to the second embodiment of the present invention;

FIGS. 28A and 28B are views for explaining an image of a first word list upon executing a fast-forward process;

FIGS. 29A and 29B are views showing an example of an abstract upon executing a fast-reverse process;

FIG. 30 is a block diagram showing the hardware arrangement of a personal computer, which implements a text-to-speech reading apparatus in the third embodiment;

FIG. 31 is a diagram showing the module configuration of a text-to-speech reading program in the third embodiment;

FIG. 32 is a flow chart showing a text-to-speech reading process of the text-to-speech reading apparatus in the third embodiment;

FIG. 33 is a flow chart showing a text-to-speech reading stop process during reading of the text-to-speech reading apparatus in the third embodiment; and

FIG. 34 is a view for explaining a method of searching for a reading restart point in the third embodiment.

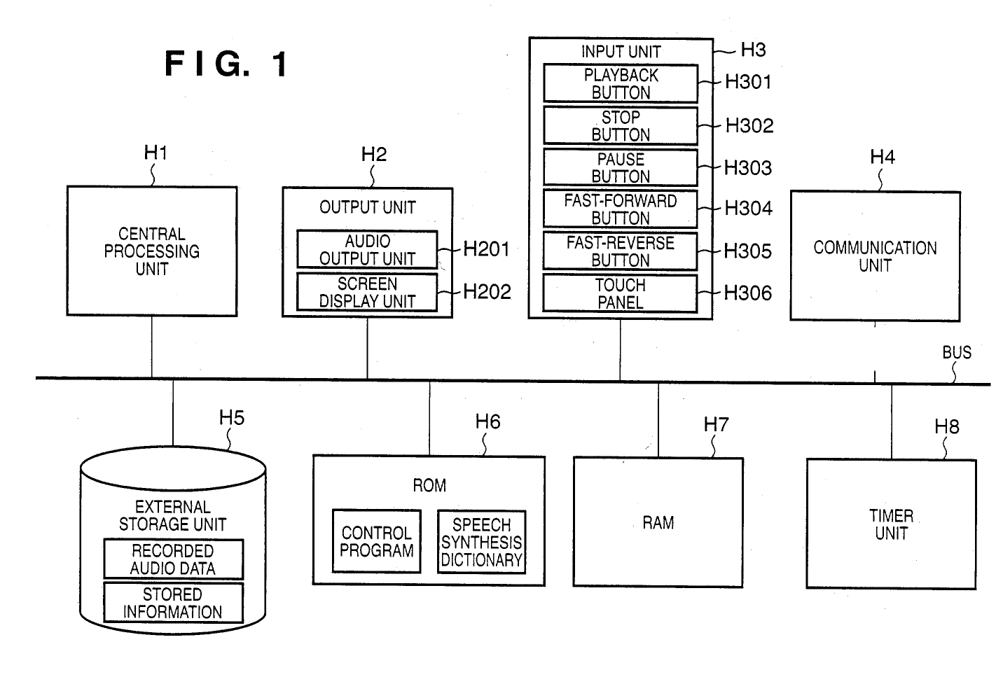

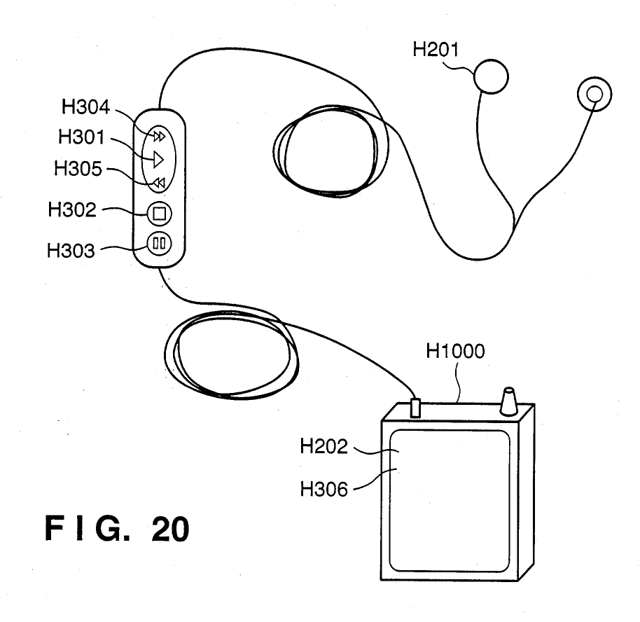

### DESCRIPTION OF THE PREFERRED EMBODIMENTS

<First Embodiment>

[Arrangement of Information Terminal: FIG. 1, FIG. 20]

FIG. 1 is a block diagram showing the hardware arrangement of a portable information terminal H1000 in the first embodiment. FIG. 20 shows an outer appearance of the information terminal H1000.

Reference numeral H1 denotes a central processing unit which executes processes such as numerical operations, control, and the like, and makes arithmetic operations in accordance with a control program that describes the processing sequence of the present invention. As will be described later, by executing this program, an audio data playback process and text-to-speech synthesis process can be selectively implemented. Reference numeral H2 denotes an output unit which presents information to the user. The output unit H2 includes an audio output unit H201 such as a loudspeaker, headphone, or the like, and a screen display unit H202 such as a liquid crystal display or the like.

Reference numeral H3 denotes an input unit at which the user issues an operation instruction to the information terminal H1000 or inputs information. The input unit H3 includes a playback button H301, stop button H302, pause button H303, fast-forward button H304, fast-reverse button H305, and a versatile input unit such as a touch panel H306 or the like.

Reference numeral H4 denotes a data communication unit such as a LAN card, PHS card, or the like, which is used to acquire data such as new arrival mail messages. Reference numeral H5 denotes a storage unit such as a hard disk, nonvolatile memory, or the like, which holds recorded data (audio data) and stored information. Reference numeral H6 denotes a read-only storage unit which stores the control program that indicates the sequence of the present invention, and permanent data such as a speech synthesis dictionary and the like.

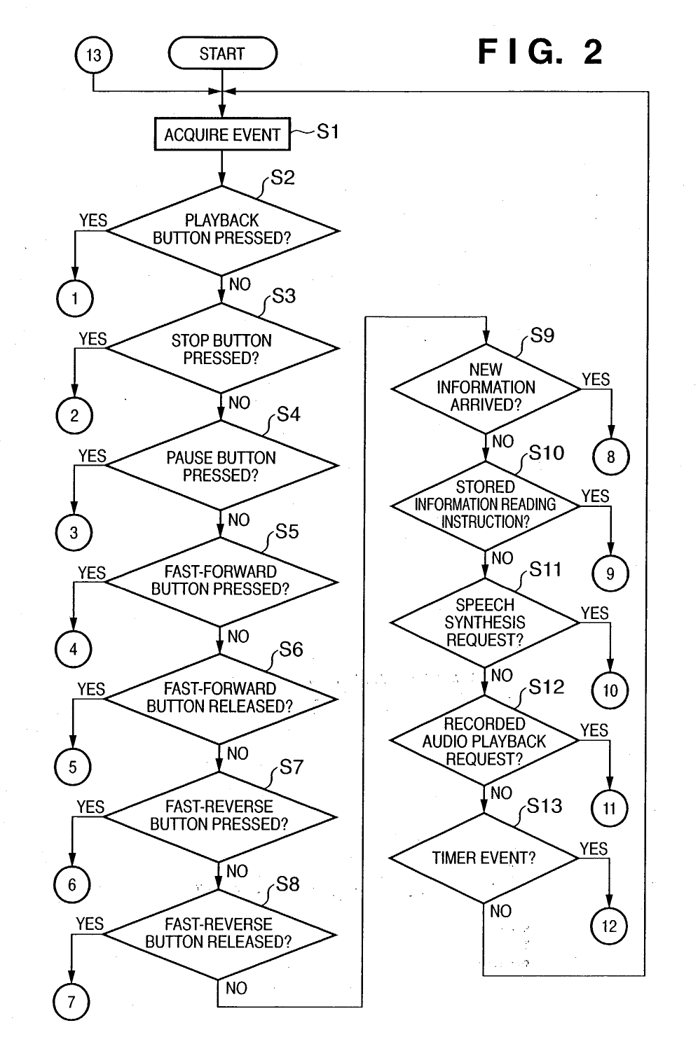

Reference numeral H7 denotes a storage unit such as a RAM or the like, which temporarily holds information. The storage unit H7 holds temporary data, various flags, and the like. Reference numeral H8 denotes an interval timer unit, which serves to generate an interrupt signal to the central processing unit H1 a predetermined period of time after the timer is launched. The central processing unit H1 to the timer unit H8 mentioned above are connected via a bus.

[Outline of Event Process: FIG. 2]

The event process in the aforementioned information terminal H1000 will be described below using the flow charts shown in FIGS. 2 to 16D. Note that the processes to be described below are executed by the central processing unit H1 using the storage unit H7 (RAM or the like) that temporarily stores information on the basis of an event-driven control program stored in the read-only storage unit H6 or the like. An input process from the input unit H3, a data request from the output unit H2, and an interrupt signal such as a timer interrupt signal or the like are processed as instructions that indicate the start of respective events in the control program.

Referring to FIG. 2, a new event is acquired in event acquisition step S1.

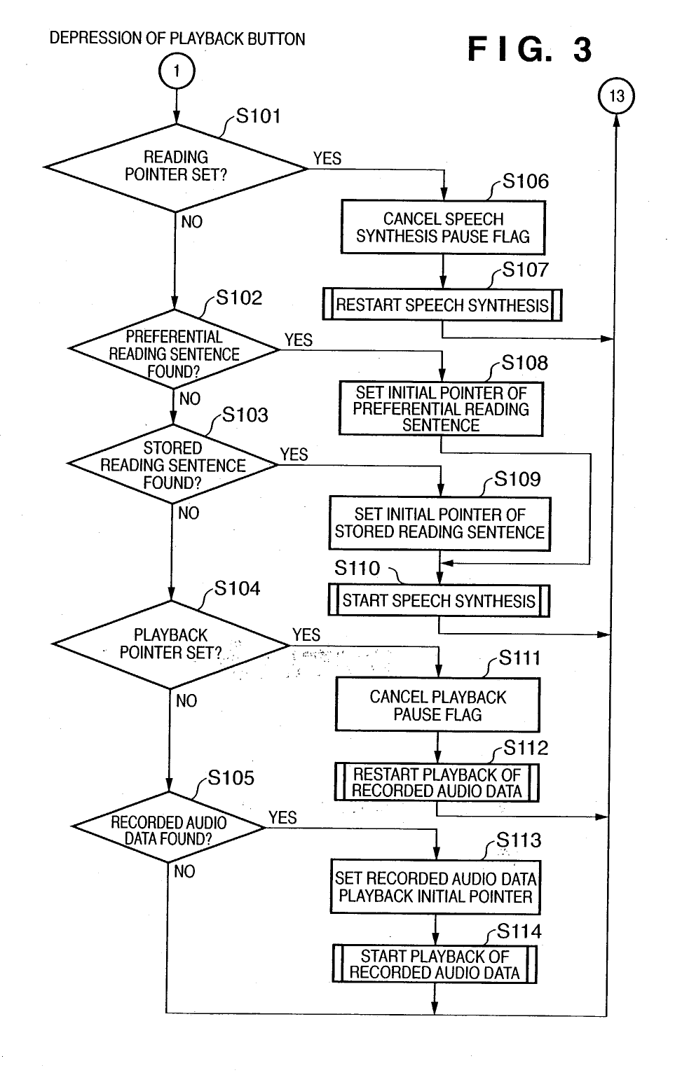

It is checked in playback button depression checking step S2 if the event acquired in event acquisition step S1 is “depression of playback button”. If the acquired event is “depression of playback button”, the flow advances to step S101 shown in FIG. 3; otherwise, the flow advances to stop button depression checking step S3.

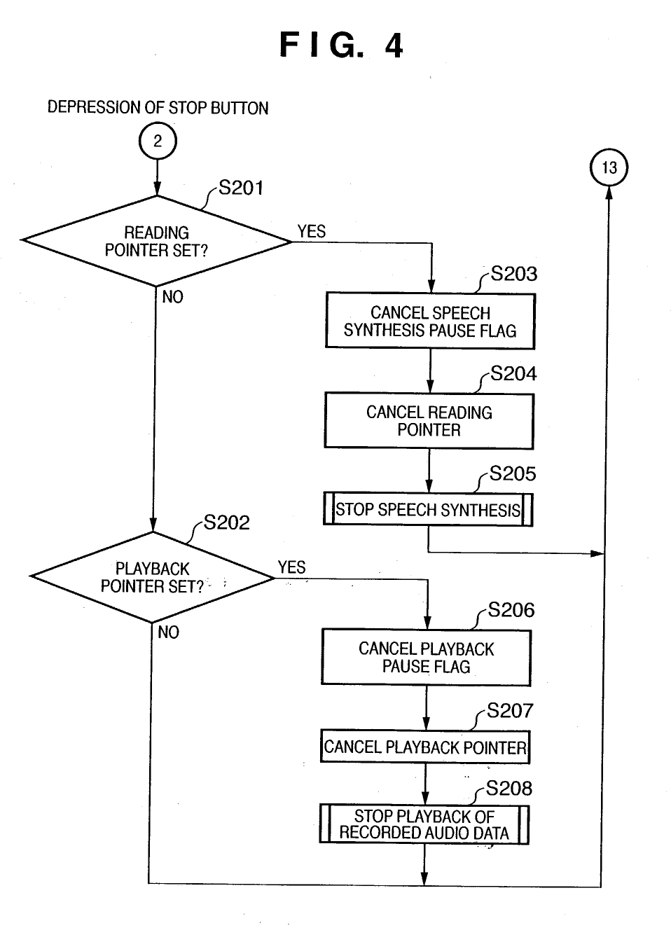

It is checked in stop button depression checking step S3 if the event acquired in event acquisition step S1 is “depression of stop button”. If the acquired event is “depression of stop button”, the flow advances to step S201 shown in FIG. 4; otherwise, the flow advances to pause button depression checking step S4.

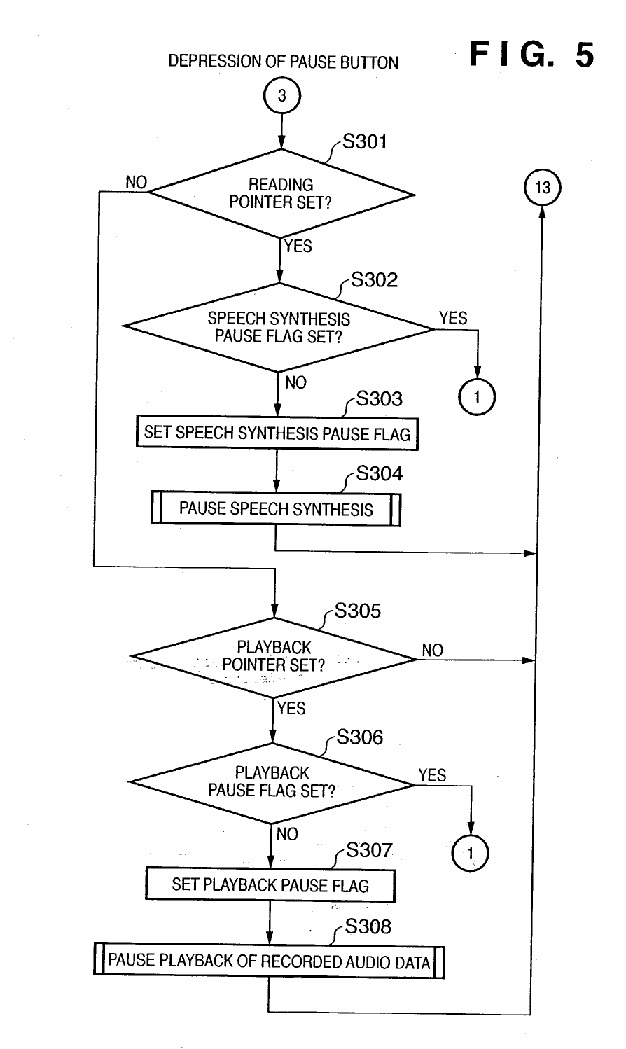

It is checked in pause button depression checking step S4 if the event acquired in event acquisition step S1 is “depression of pause button”. If the acquired event is “depression of pause button”, the flow advances to step S301 shown in FIG. 5; otherwise, the flow advances to fast-forward button depression checking step S5.

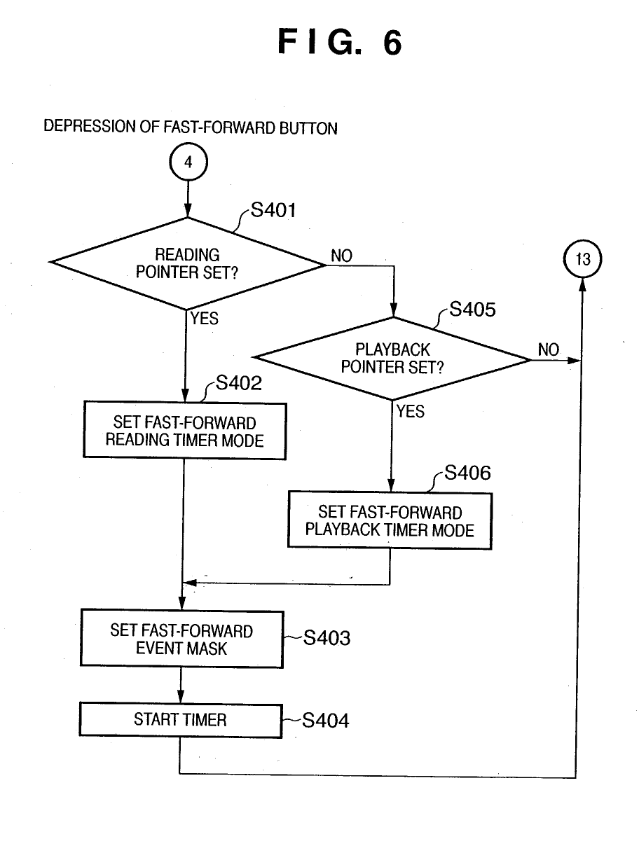

It is checked in fast-forward button depression checking step S5 if the event acquired in event acquisition step S1 is “depression of fast-forward button”. If the acquired event is “depression of fast-forward button”, the flow advances to step S401 shown in FIG. 6; otherwise, the flow advances to fast-forward button release checking step S6.

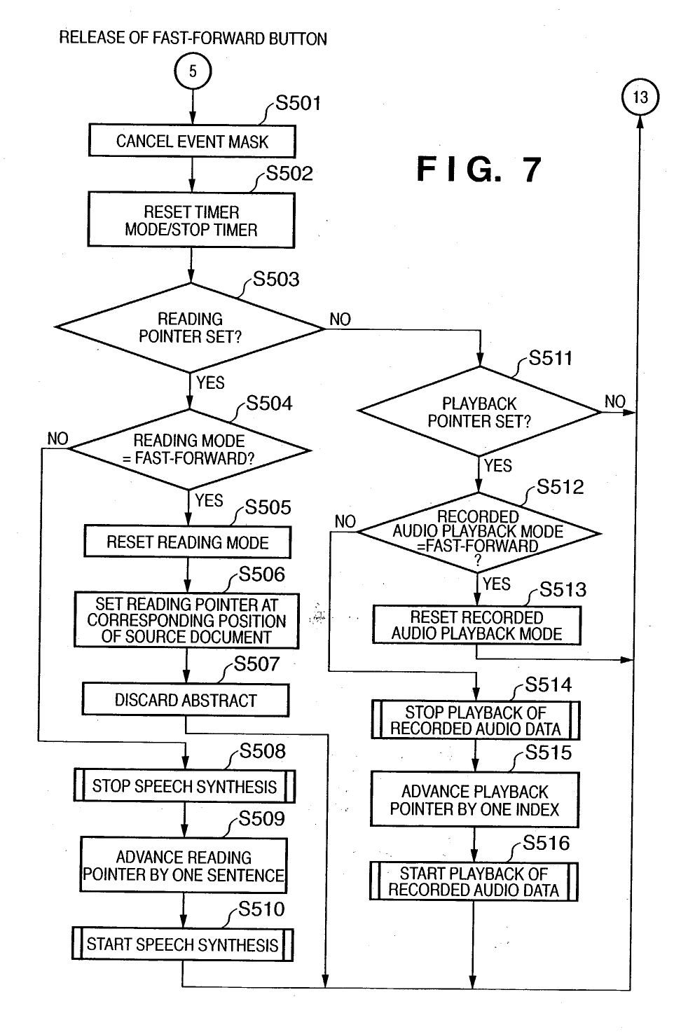

It is checked in fast-forward button release checking step S6 if the event acquired in event acquisition step S1 is “release of fast-forward button (operation for releasing the pressed button)”. If the acquired event is “release of fast-forward button”, the flow advances to step S501 shown in FIG. 7; otherwise, the flow advances to fast-reverse button depression checking step S7.

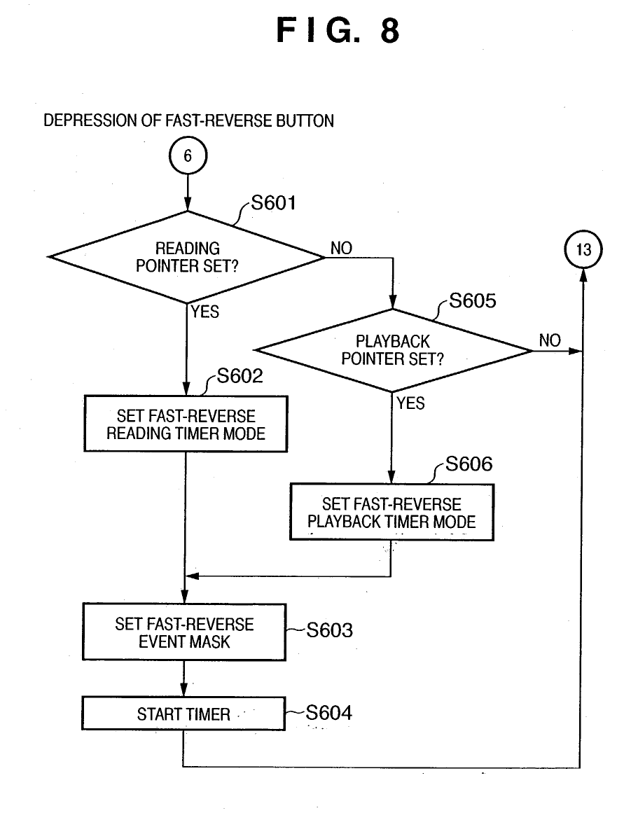

It is checked in fast-reverse button depression checking step S7 if the event acquired in event acquisition step S1 is “depression of fast-reverse button”. If the acquired event is “depression of fast-reverse button”, the flow advances to step S601 shown in FIG. 8; otherwise, the flow advances to fast-reverse button release checking step S8.

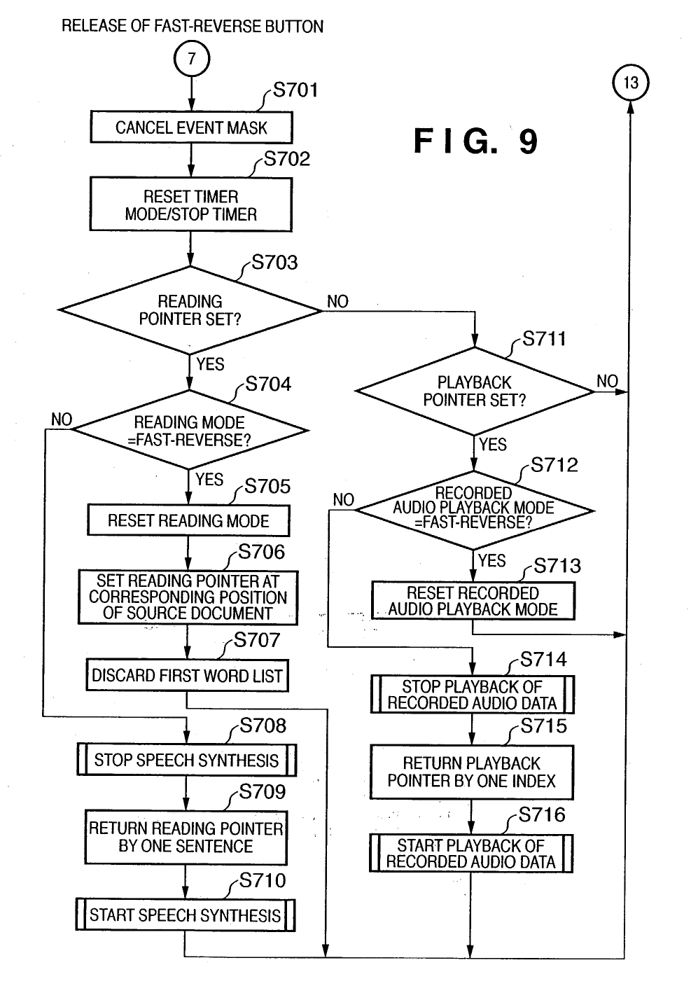

It is checked in fast-reverse button release checking step S8 if the event acquired in event acquisition step S1 is “release of fast-reverse button”. If the acquired event is “release of fast-reverse button”, the flow advances to step S701 shown in FIG. 9; otherwise, the flow advances to new information arrival checking step S9.

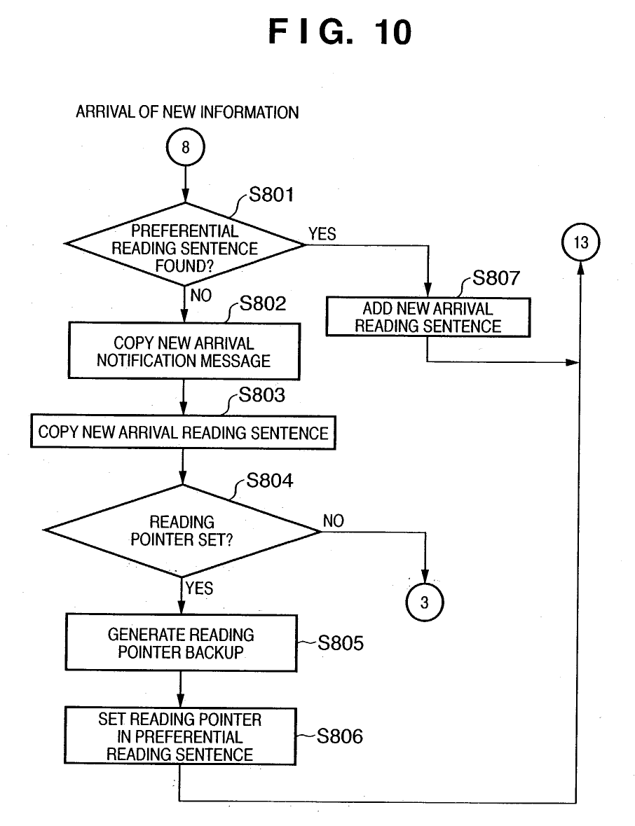

It is checked in new information arrival checking step S9 if the event acquired in event acquisition step S1 indicates arrival of “new information”. If the acquired event indicates arrival of “new information”, the flow advances to step S801 shown in FIG. 10; otherwise, the flow advances to stored information reading instruction checking step S10.

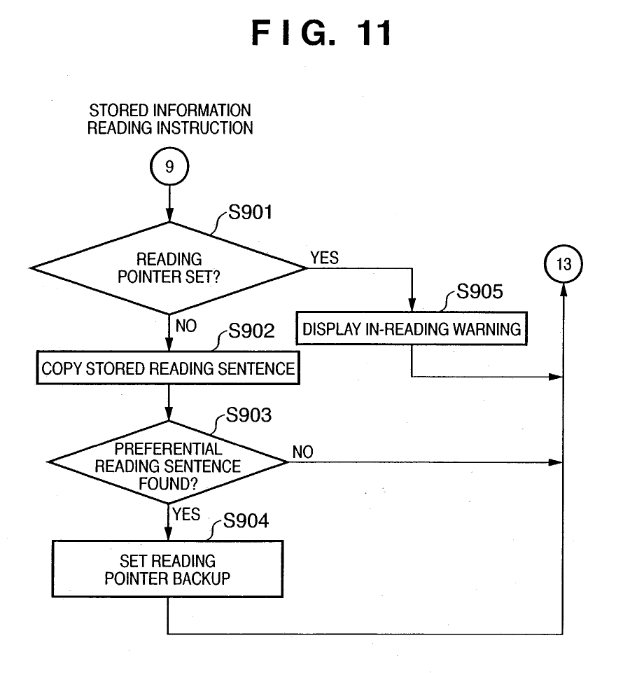

It is checked in stored information reading instruction checking step S10 if the event acquired in event acquisition step S1 is “user's stored information reading instruction”. If the acquired event is “user's stored information reading instruction”, the flow advances to step S901 shown in FIG. 11; otherwise, the flow advances to speech synthesis data request checking step S11.

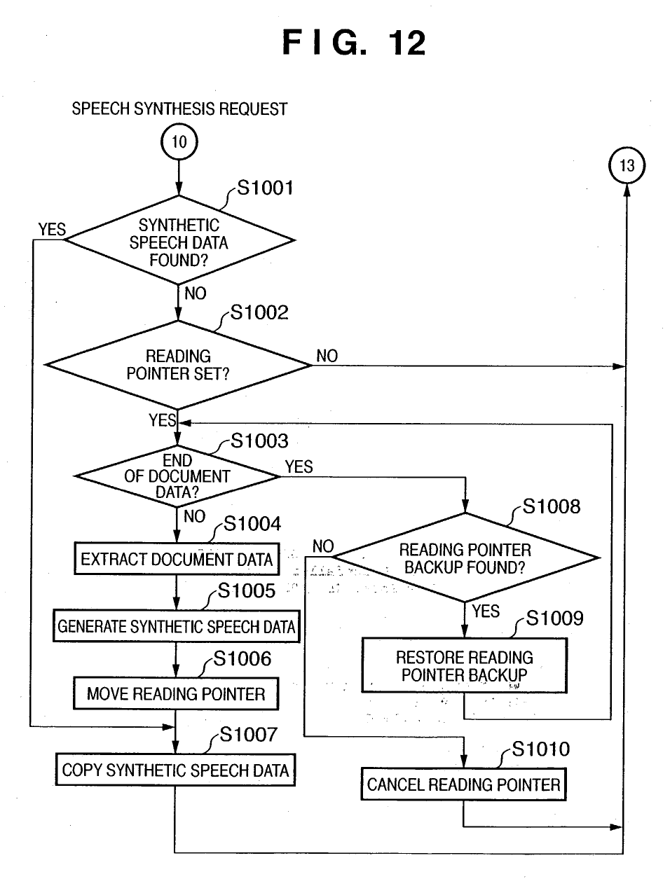

It is checked in speech synthesis data request checking step S11 if the event acquired in event acquisition step S1 is “data request from synthetic speech output device”. If the acquired event is “data request from synthetic speech output device”, the flow advances to step S1001 shown in FIG. 12; otherwise, the flow advances to recorded audio playback data request checking step S12.

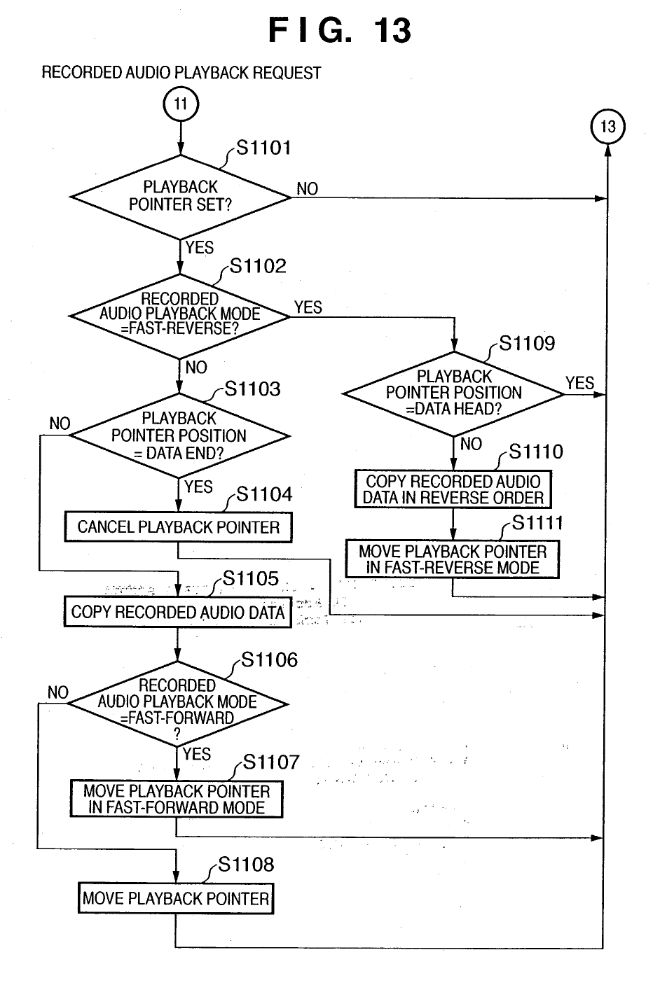

It is checked in recorded audio playback data request checking step S12 if the event acquired in event acquisition step S1 is “data request from recorded audio data output device”. If the acquired event is “data request from recorded audio data output device”, the flow advances to step S1101 shown in FIG. 13; otherwise, the flow advances to timer event checking step S13.

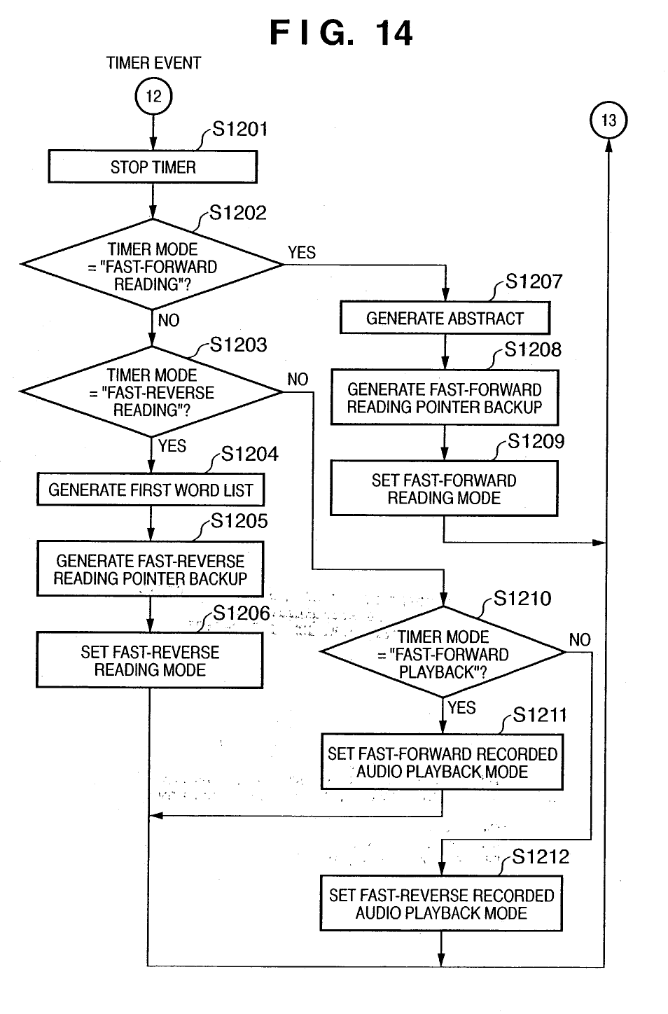

It is checked in timer event checking step S13 if the event acquired in event acquisition step S1 is a message which is sent from the timer unit H8 and indicates an elapse of a predetermined period of time after the timer has started. If the acquired event is the message from the timer unit H8, the flow advances to step S1201 shown in FIG. 14; otherwise, the flow returns to event acquisition step S1.

[“Depression of Playback Button” Process: FIG. 3]

The processes of the aforementioned events will be described in detail hereinafter. The “depression of playback button” process will be explained first using FIG. 3.

[Reading Pointer]

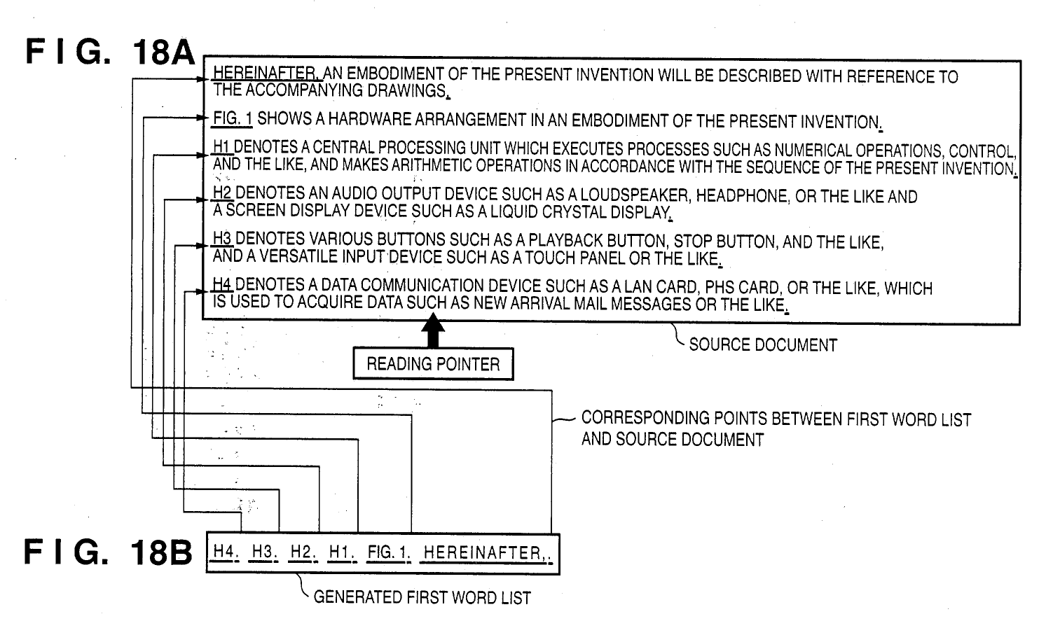

It is checked in reading pointer setup checking (playback) step S101 if a “reading pointer” is set. If the “reading pointer” is set, the flow advances to speech synthesis pause flag cancel (playback) step S106; otherwise, the flow advances to preferential reading sentence presence checking (playback) step S102. Note that the “reading pointer” is a field that holds the reading start position using speech synthesis in the middle of a preferential reading sentence (text data) exemplified in FIGS. 18A, and is disabled or is set with the position of the “reading pointer” as a value.

It is checked in preferential reading sentence presence checking (playback) step S102 if a “preferential reading sentence is present”. If the “preferential reading sentence is present”, the flow advances to preferential reading sentence initial pointer setting step S108; otherwise, stored reading sentence presence checking step S103.

It is checked in stored reading sentence presence checking step S103 if a “stored reading sentence is present”. If the “stored reading sentence is present”, the flow advances to stored reading sentence initial pointer setting step S109; otherwise, the flow advances to playback pointer setup checking (playback) step S104.

[Playback Pointer]

It is checked in playback pointer setup checking (playback) step S104 if a “playback pointer is set”. If the “playback pointer is set”, the flow advances to playback pause flag cancel (playback) step S111; otherwise, the flow advances to recorded audio data presence checking step S105. Note that the “playback pointer” is a field that holds the next playback position, and is disabled or is set with the position of the “playback pointer” in recorded audio data as a value.

It is checked in recorded audio data presence checking step S105 if “recorded audio data is present”. If the “recorded audio data is present”, the flow advances to recorded audio data playback initial pointer setting step S113; otherwise, the flow returns to event acquisition step S1 in FIG. 2.

In speech synthesis pause flag cancel (playback) step S106, a speech synthesis pause flag is canceled. The speech synthesis pause flag indicates if speech synthesis is paused, and assumes a “true” value if it is set; a “false” value if it is canceled.

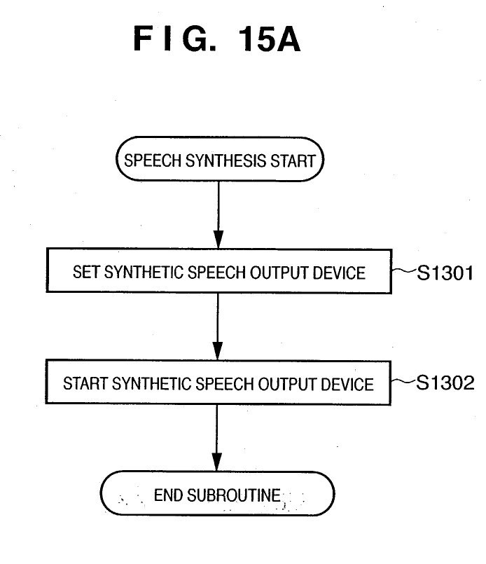

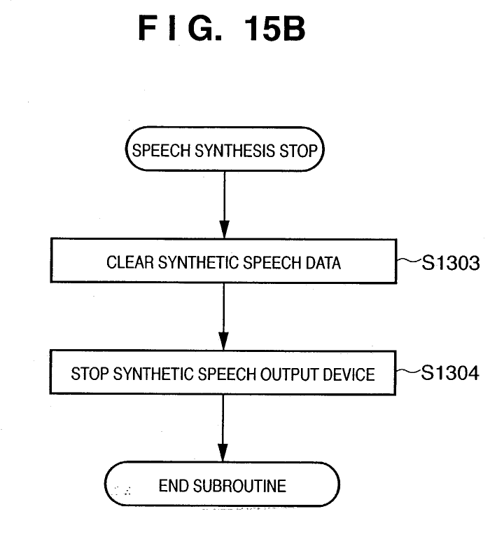

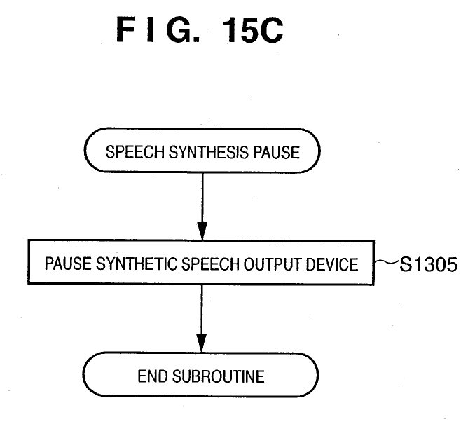

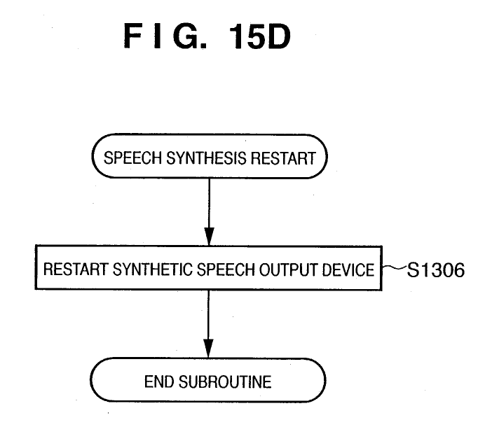

In speech synthesis restart (playback) step S107, speech synthesis which has been paused in step S304 in FIG. 5 is restarted, and the flow then returns to event acquisition step S1 in FIG. 2. Processes in “speech synthesis start”, “speech synthesis stop”, “speech synthesis pause”, and “speech synthesis restart” routines will be described later using FIGS. 15A to 15D.

In preferential reading sentence initial pointer setting step S108, the reading pointer is set at the head of a preferential reading sentence, and the flow jumps to speech synthesis start step S110.

In stored reading sentence initial pointer setting step S109, the reading pointer is set at the head of a stored reading sentence, and the flow advances to speech synthesis start step S110.

After the reading pointer is set in preferential reading sentence initial pointer setting step S108 or stored reading sentence initial pointer setting step S109, speech synthesis is started in speech synthesis start step S110, and the flow then returns to event acquisition step S1 in FIG. 2.

In playback pause flag cancel (playback) step S111, a playback pause flag is canceled. The playback pause flag indicates if recorded audio data playback is paused.

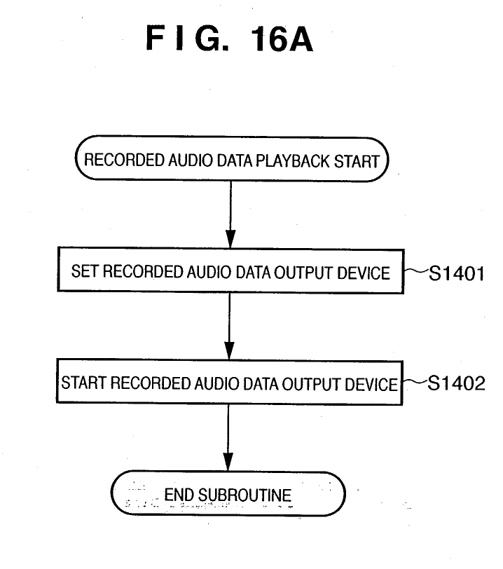

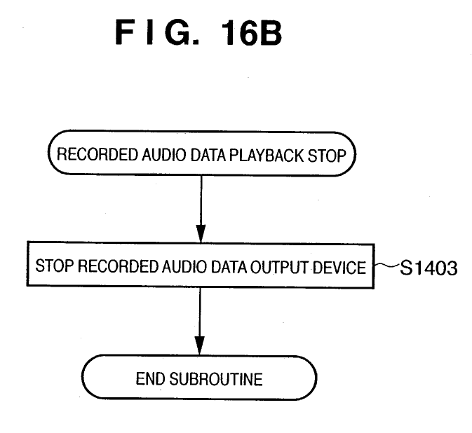

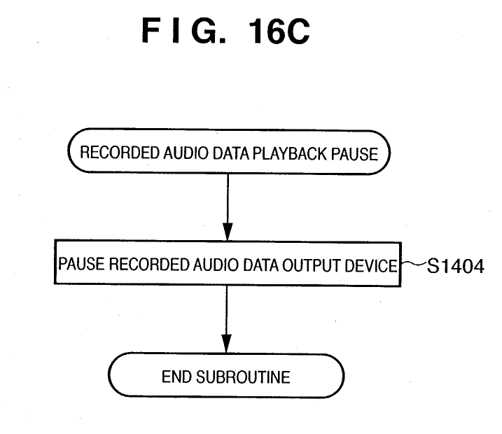

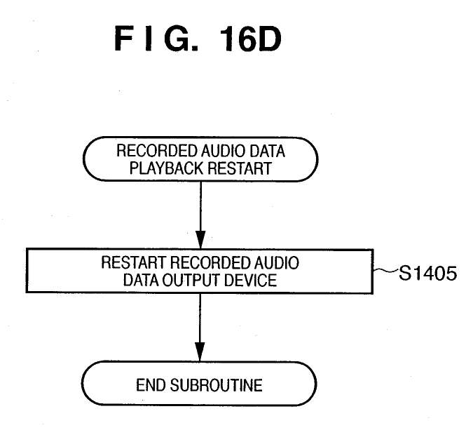

In recorded audio data playback restart (playback) step S112, playback of recorded audio data, which has been paused in step S308 is restarted, and the flow then returns to event acquisition step S1. Processes in “recorded audio data playback start”, “recorded audio data playback stop”, “recorded audio data playback pause”, and “recorded audio data playback restart” routines will be described later using FIGS. 16A to 16D.

In recorded audio data playback initial pointer setting step S113, the playback pointer is set at the head of recorded audio data, and the flow advances to recorded audio data playback start step S114. In recorded audio data playback start step S114, playback of recorded audio data is started, and the flow then returns to event acquisition step S1 in FIG. 2.

[“Depression of Stop Button” Process: FIG. 4]

The “depression of stop button” process will be described below using FIG. 4.

It is checked in reading pointer setup checking (stop) step S201 if the “reading pointer” is set. If the “reading pointer” is set, the flow advances to speech synthesis pause flag cancel (stop) step S203; otherwise, the flow advances to playback pointer setup checking (stop) step S202.

It is checked in playback pointer setup checking (stop) step S202 if the “playback pointer” is set. If the “playback pointer” is set, the flow advances to playback pause flag cancel (stop) step S206; otherwise, the flow then returns to event acquisition step S1.

In speech synthesis pause flag cancel (stop) step S203, a speech synthesis pause flag is canceled. In reading pointer cancel (stop) step S204, the reading pointer is canceled (disabled). In speech synthesis stop step S205, speech synthesis is stopped, and the flow then returns to event acquisition step S1 in FIG. 2.

In playback pause flag cancel (stop) step S206, the playback pause flag is canceled. In playback pointer cancel (stop) step S207, the playback pointer is canceled (disabled). In recorded audio data playback stop step S208, playback of recorded audio data is stopped, and the flow then returns to event acquisition step S1 in FIG. 2.

[“Depression of Pause Button” Process: FIG. 5]

The “depression of pause button” process will be described below using FIG. 5.

It is checked in reading pointer setup checking (pause) step S301 if the “reading pointer” is set. If the “reading pointer” is set, the flow advances to speech synthesis pause flag setup checking step S302; otherwise, the flow jumps to playback pointer setup checking (pause) step S305.

It is checked in speech synthesis pause flag setup checking step S302 if the speech synthesis pause flag is set, i.e., if speech synthesis is paused. If the speech synthesis pause flag is set, the flow advances to reading pointer setup checking (playback) step S101 in FIG. 3; otherwise, the flow advances to speech synthesis pause flag setting step S303.

In speech synthesis pause flag setting step S303, the speech synthesis pause flag is set (set with a “true” value). In speech synthesis pause step S304, speech synthesis is paused, and the flow then returns to event acquisition step S1 in FIG. 2.

It is checked in playback pointer setup checking (pause) step S305 if the “playback pointer” is set. If the “playback pointer” is set, the flow advances to playback pause flag setup checking step S306; otherwise, the flow returns to event acquisition step S1 in FIG. 2.

It is checked in playback pause flag setup checking step S306 if a “playback pause flag” is set, i.e., if playback of recorded audio data is paused. If the “playback pause flag” is set, the flow advances to reading pointer setup checking (playback) step S101 in FIG. 3; otherwise, the flow advances to playback pause flag setting step S307.

In playback pause flag setting step S307, the playback pause flag is set (set with a “true” value). In recorded audio data playback pause step S308, playback of recorded audio data is paused, and the flow then returns to event acquisition step S1 in FIG. 2.

[“Depression of Fast-Forward Button” Process: FIG. 6]

The “depression of fast-forward button” process will be described below using FIG. 6.

It is checked in reading pointer setup checking (fast-forward) step S401 if the “reading pointer” is set. If the “reading pointer” is set, the flow advances to fast-forward reading timer mode setting step S402; otherwise, the flow advances to playback pointer setup checking (fast-forward) step S405.

In fast-forward reading timer mode setting step S402, a timer mode is set to be “fast-forward reading”, and the flow advances to fast-forward event mask setting step S403. The timer mode indicates the purpose of use of the timer.

In fast-forward event mask setting step S403, an event mask is set for a fast-forward process to limit an event to be acquired in event acquisition step S1 to only “release of fast-forward button”, “speech synthesis data request”, “recorded audio playback data request”, and “timer event”.

In timer start (fast-forward) step S404, the timer is started so that a timer event occurs after an elapse of a predetermined period of time. The flow then returns to event acquisition step S1 in FIG. 2.

It is checked in playback pointer setup checking (fast-forward) step S405 if the playback pointer is set. If the playback pointer is set, the flow advances to fast-forward playback timer mode setting step S406; otherwise, the flow returns to event acquisition step S1 in FIG. 2.

In fast-forward playback timer mode setting step S406, the timer mode is set to be “fast-forward playback”, and the flow advances to fast-forward event mask setting step S403.

[“Release of Fast-Forward Button” Process: FIG. 7]

The “release of fast-forward button” process will be described below using FIG. 7.

In event mask cancel (fast-forward) step S501, the event mask is canceled, so that all events are allowed to be acquired in subsequent event acquisition step S1.

In timer mode reset/timer stop (fast-forward) step S502, the timer mode is reset, and the timer is then stopped.

It is checked in reading pointer setup checking (fast-forward release) step S503 if the “reading pointer” is set. If the “reading pointer” is set, the flow advances to reading mode checking (fast-forward) step S504; otherwise, the flow advances to playback pointer setup checking (fast-forward release) step S511.

It is checked in reading mode checking (fast-forward) step S504 if a reading mode is “fast-forward”. If the reading mode is “fast-forward”, the flow advances to reading mode reset (fast-forward) step S505; otherwise, the flow jumps to speech synthesis stop (fast-forward) step S508.

In reading mode reset (fast-forward) step S505, the reading mode is reset. In reading pointer restore (fast-forward) step S506, the reading pointer set in an abstract generated in step S1207 in FIG. 14 is set at a corresponding position in a source document.

In abstract discard step S507, the abstract is discarded, and the flow then returns to event acquisition step S1 in FIG. 2.

In speech synthesis stop (fast-forward) step S508, speech synthesis is stopped. In reading pointer forward skip step S509, the reading pointer is moved to the head of a sentence next to the sentence which is being currently read aloud. In speech synthesis start (fast-forward) step S510, speech synthesis is started, and the flow then returns to event acquisition step S1 in FIG. 2.

On the other hand, it is checked in playback pointer setup checking (fast-forward release) step S511 if the “playback pointer” is set. If the “playback pointer” is set, the flow advances to recorded audio playback mode checking (fast-forward) step S512; otherwise, the flow returns to event acquisition step Si in FIG. 2.

It is checked in recorded audio playback mode checking (fast-forward) step S512 if a recorded audio playback mode is “fast-forward”. If the recorded audio playback mode is “fast-forward”, the flow advances to recorded audio playback mode reset (fast-forward) step S513; otherwise, the flow jumps to recorded audio data playback stop (fast-forward) step S514.

In recorded audio playback mode reset (fast-forward) step S513, the recorded audio playback mode is reset, and the flow then returns to event acquisition step S1 in FIG. 2. In recorded audio data playback stop (fast-forward) step S514, playback of recorded audio data is stopped. In playback pointer forward skip step S515, the playback pointer is advanced one index. For example, if recorded audio data is music data, the playback pointer moves to the head of the next song.

In recorded audio data playback start (fast-forward) step S516, playback of recorded audio data is started, and the flow then returns to event acquisition step S1 in FIG. 2.

[“Depression of Fast-Reverse Button” Process: FIG. 8]

The “depression of fast-reverse button” process will be described below using FIG. 8.

It is checked in reading pointer setup checking (fast-reverse) step S601 if the “reading pointer is set”. If the “reading pointer is set”, the flow advances to fast-reverse reading timer mode setting step S602; otherwise, the flow advances to playback pointer setup checking (fast-reverse) step S605.

In fast-reverse reading timer mode setting step S602, the timer mode is set to be “fast-reverse reading”, and the flow then advances to fast-reverse event mask setting step S603.

In fast-reverse event mask setting step S603, the event mask is set for a fast-reverse process to limit an event to be acquired in event acquisition step S1 in FIG. 2 to only “release of fast-reverse button”, “speech synthesis data request”, “recorded audio playback data request”, and “timer event”.

In timer start (fast-reverse) step S604, the timer is started so that a timer event occurs after an elapse of a predetermined period of time. The flow then returns to event acquisition step S1 in FIG. 2.

It is checked in playback pointer setup checking (fast-reverse) step S605 if the “playback pointer” is set. If the “playback pointer” is set, the flow advances to fast-reverse playback timer mode setting step S606; otherwise, the flow returns to event acquisition step S1 in FIG. 2.

In fast-reverse playback timer mode setting step S606, the timer mode is set to be “fast-reverse playback”, and the flow advances to fast-reverse event mask setting step S603.

[“Release of Fast-Reverse Button” Process: FIG. 9]

The “release of fast-reverse button” process will be described below using FIG. 9.

In event mask cancel (fast-reverse) step S701, the event mask is canceled, so that all events are allowed to be acquired in subsequent event acquisition step S1.

In timer mode reset/timer stop (fast-reverse) step S702, the timer mode is reset, and the timer is then stopped.

It is checked in reading pointer setup checking (fast-reverse release) step S703 if the “reading pointer” is set. If the “reading pointer” is set, the flow advances to reading mode checking (fast-reverse) step S704; otherwise, the flow advances to playback pointer setup checking (fast-reverse release) step S711.

It is checked in reading mode checking (fast-reverse) step S704 if a reading mode is “fast-reverse”. If the reading mode is “fast-reverse”, the flow advances to reading mode reset (fast-reverse) step S705; otherwise, the flow jumps to speech synthesis stop (fast-reverse) step S708.

In reading mode reset (fast-reverse) step S705, the reading mode is reset. In reading pointer restore (fast-reverse) step S706, the reading pointer set in a first word list generated in step S1204 in FIG. 14 is set at a corresponding position in a source document (using information generated in step S1205).

In first word list discard step S707, the first word list is discarded, and the flow then returns to event acquisition step S1 in FIG. 2.

In speech synthesis stop (fast-reverse) step S708, speech synthesis is stopped. In reading pointer backward skip step S709, the reading pointer is moved to the head of a sentence before the sentence which is being currently read aloud.

In speech synthesis start (fast-reverse) step S710, speech synthesis is started, and the flow then returns to event acquisition step S1 in FIG. 2.

It is checked in playback pointer setup checking (fast-reverse release) step S711 if the “playback pointer” is set. If the “playback pointer” is set, the flow advances to recorded audio playback mode checking (fast-reverse) step S712; otherwise, the flow returns to event acquisition step S1 in FIG. 2.

It is checked in recorded audio playback mode checking (fast-reverse) step S712 if a recorded audio playback mode is “fast-reverse”. If the recorded audio playback mode is “fast-reverse”, the flow advances to recorded audio playback mode reset (fast-reverse) step S713; otherwise, the flow jumps to recorded audio data playback stop (fast-reverse) step S714.

In recorded audio playback mode reset (fast-reverse) step S713, the recorded audio playback mode is reset, and the flow then returns to event acquisition step S1 in FIG. 2.

In recorded audio data playback stop (fast-reverse) step S714, playback of recorded audio data is stopped. In playback pointer backward skip step S715, the playback pointer is returned one index. For example, if recorded audio data is music data and the playback pointer does not overlap any index, the playback pointer moves to the head of the current song.

In recorded audio data playback start (fast-reverse) step S716, playback of recorded audio data is started, and the flow then returns to event acquisition step S1 in FIG. 2.

[“Arrival of New Information” Process: FIG. 10]

The “arrival of new information” process will be described below using FIG. 10.

It is checked in preferential reading sentence presence checking (new arrival) step S801 if a preferential reading sentence is present. If the preferential reading sentence is present, the flow advances to new arrival reading sentence adding step S807; otherwise, the flow advances to new arrival notification message copy step S802.

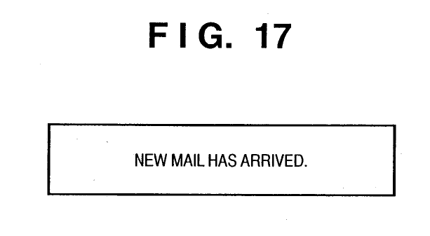

In new arrival notification message copy step S802, a new arrival notification message is copied to the head of the preferential reading sentence. FIG. 17 shows an example of the new arrival notification message.

In new arrival reading sentence copy step S803, the new reading sentence is copied to a position behind the new arrival notification message in the preferential reading sentence.

It is checked in reading pointer setup checking (new arrival) step S804 if the reading pointer is set. If the reading pointer is set, the flow advances to reading pointer backup generation (new arrival) step S805; otherwise, the flow advances to step S101.

In reading pointer backup generation (new arrival) step S805, the current value of the reading pointer is held as additional information for the preferential reading sentence.

In new arrival reading pointer setting step S806, the reading pointer is set at the head of the preferential reading sentence, and the flow returns to event acquisition step S1.

In new arrival reading sentence adding step S807, a new arrival reading sentence to the end of the preferential reading sentence, and the flow then returns to event acquisition step S1 in FIG. 2.

[“Stored Information Reading Instruction” Process: FIG. 11]

The “stored information reading instruction” process will be described below using FIG. 11.

It is checked in reading pointer setup checking (stored information reading) step S901 if the “reading pointer is set”. If the “reading pointer is set”, the flow advances to reading-underway warning display step S905; otherwise, the flow advances to stored reading sentence copy step S902.

In stored reading sentence copy step S902, information instructed in stored information reading instruction checking step S10 is copied from information stored in the external storage unit H5 to a stored reading sentence.

It is checked in preferential reading sentence presence checking (stored information reading) step S903 if a “preferential reading sentence is present”. If the “preferential reading sentence is present”, the flow advances to reading pointer backup setting step S904; otherwise, the flow returns to event acquisition step S1.

In reading pointer backup setting step S904, the head of the stored reading sentence is set as additional information for the preferential reading sentence, and the flow then returns to event acquisition step S1 in FIG. 2.

In reading-underway warning display step S905, a warning indicating that reading is now underway is output, and the flow then returns to event acquisition step S1 in FIG. 2.

[“Speech Synthesis Request Instruction” Process: FIG. 12]

The “speech synthesis request instruction” process will be described below using FIG. 12.

It is checked in synthetic speech data presence checking step S1001 if “waveform data” which has been converted from text into a speech waveform is already present. If the “waveform data” is present, the flow jumps to synthetic speech data copy step S1007; otherwise, the flow advances to reading pointer setup checking (speech output) step S1002.

It is checked in reading pointer setup checking (speech output) step S1002 if the “reading pointer is set”. If the “reading pointer is set”, the flow advances to document data end checking step S1003; otherwise, the flow returns to event acquisition step S1 in FIG. 2.

It is checked in document data end checking step S1003 if the “reading pointer has reached the end of document data”. If the “reading pointer has reached the end of document data”, the flow advances to reading pointer backup presence checking step S1008; otherwise, the flow advances to document data extraction step S1004.

In document data extraction step S1004, data of a given size (for, e.g., one sentence) is extracted from document data. In synthetic speech data generation step S1005, the extracted data undergoes a speech synthesis process to obtain synthetic speech data.

In reading pointer moving step S1006, the reading pointer is moved by the size of data extracted in document data extraction step S1004, and the flow advances to synthetic speech data copy step S1007.

In synthetic speech data copy step S1007, data of a given size (the buffer size of a synthetic speech output device) is output from the synthetic speech data to the synthetic speech output device, and the flow then returns to event acquisition step S1.

It is checked in reading pointer backup presence checking step S1008 if a “backup of the reading pointer is present” as additional information of document data. If the “backup of the reading pointer is present”, the flow advances to reading pointer backup restore step S1009; otherwise, the flow jumps to reading pointer cancel step S1010.

In reading pointer backup restore step S1009, the backup of the reading pointer appended to the document data is set as a reading pointer, and the flow advances to document data end checking step S1003.

In reading pointer cancel step S1010, the reading pointer is canceled (disabled). The flow then returns to event acquisition step S1.

[“Recorded Audio Playback Request Instruction” Process: FIG. 13]

The “recorded audio playback request instruction” process will be described below using FIG. 13.

It is checked in playback pointer setup checking (recorded audio playback) step S1101 if the “playback pointer is set”. If the “playback pointer is set”, the flow advances to recorded audio playback mode checking (fast-reverse 2) step S1102; otherwise, the flow returns to event acquisition step S1.

It is checked in recorded audio playback mode checking (fast-reverse 2) step S1102 if a recorded audio playback mode is “fast-reverse”. If the recorded audio playback mode is “fast-reverse”, the flow advances to playback pointer head checking step S1109; otherwise, the flow advances to playback pointer end checking step S1103.

It is checked in playback pointer end checking step S1103 if the “playback pointer has reached the end (last) of recorded audio data”. If the “playback pointer has reached the end (last) of recorded audio data”, the flow advances to playback pointer cancel step S1104; otherwise, the flow jumps to recorded audio data copy step S1105.

In playback pointer cancel step S1104, the playback pointer is canceled, and the flow then returns to event acquisition step S1.

In recorded audio data copy step S1105, data of a given size (the buffer size of a recorded audio data output device) is output from the recorded audio data to the recorded audio data output device, and the flow advances to recorded audio playback mode checking (fast-forward 2) step S1106.

It is checked in recorded audio playback mode checking (fast-forward 2) step S1106 if the “recorded audio playback mode is fast-forward”. If the “recorded audio playback mode is fast-forward”, the flow advances to playback pointer fast-forward moving step S1107; otherwise, the flow jumps to playback pointer moving step S1108.

In playback pointer fast-forward moving step S1107, the playback pointer is advanced by a size larger than that output in recorded audio data copy step S1105 (e.g., 10 times of the predetermined size), and the flow then returns to event acquisition step S1 in FIG. 2.

In playback pointer moving step S1108, the playback pointer is advanced by the size output in recorded audio data copy step S1105, and the flow then returns to event acquisition step S1 in FIG. 2.

It is checked in playback pointer head checking step S1109 if the “playback pointer indicates the head of recorded audio data”. If the “playback pointer indicates the head of recorded audio data”, the flow returns to event acquisition step S1; otherwise, the flow advances to recorded audio data reverse order copy step S1110.

In recorded audio data reverse order copy step S1110, data of the given size (the buffer size of the recorded audio data output device) is output to the recorded audio data output device as in recorded audio data copy step S1105. In this case, the data is output in the reverse order.

In playback pointer fast-reverse moving step S1111, the playback pointer is moved in a direction opposite to that in the playback process, and the flow then returns to event acquisition step S1 in FIG. 2.

[“Timer Event” Process: FIG. 14]

The “timer event” process will be described below using FIG. 14.

In timer stop step S1201, the timer is stopped.

It is checked in timer mode checking (fast-forward reading) step S1202 if the timer mode is “fast-forward reading”. If the timer mode is “fast-forward reading”, the flow advances to abstract generation step S1207; otherwise, the flow advances to timer mode checking (fast-reverse reading) step S1203.

It is checked in timer mode checking (fast-reverse reading) step S1203 if the timer mode is “fast-reverse reading”. If the timer mode is “fast-reverse reading”, the flow advances to first word list generation step S1204; otherwise, the flow advances to timer mode checking (fast-forward playback) step S1210.

In first word list generation step S1204, a list of words at the head of respective sentences which are present from the head of the document indicated by the reading pointer to the position of the reading pointer is generated. FIGS. 18A and 18B show example of the first word list. FIG. 18A indicates a source document, and FIG. 18B indicates an image of the generated first word list. Note that the position of the reading pointer is set so that the reading pointer is located at the end of the read document. When a document is read aloud, the position of the reading pointer moves in synchronism with the reading process.

In fast-reverse reading pointer backup generation step S1205, corresponding points to which the reading pointer is to be moved upon restoring from the fast-reverse mode are generated. In FIGS. 18A and 18B, arrows which connect the first word list and source document are the corresponding points.

In fast-reverse reading mode setting step S1206, the reading mode is set to be “fast-reverse”, and the flow then returns to event acquisition step S1 in FIG. 2.

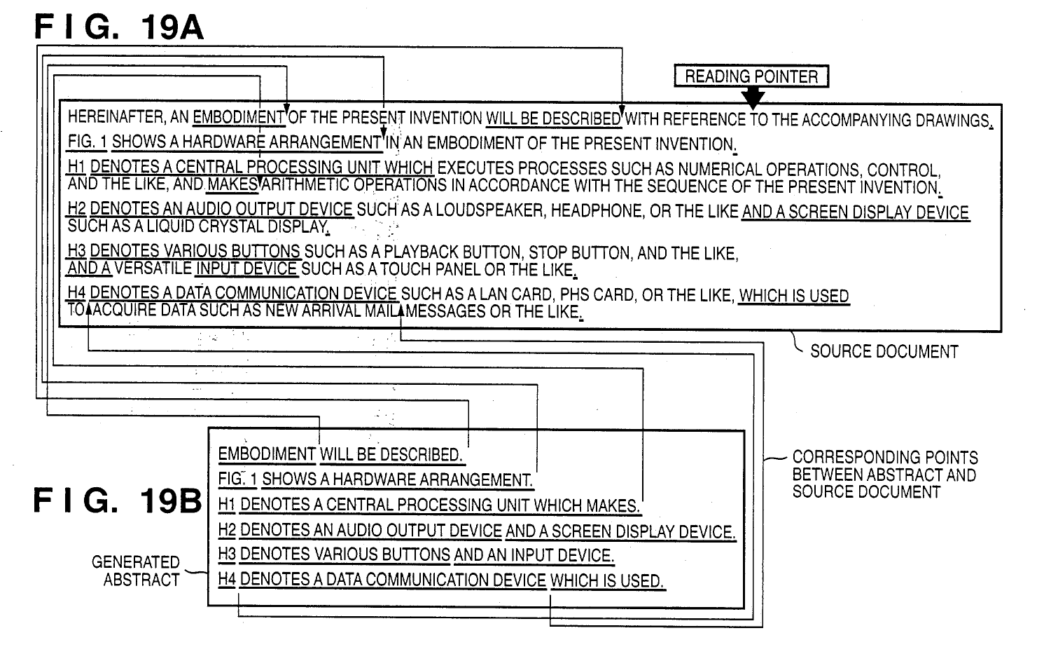

In abstract generation step S1207, an abstract from the position indicated by the reading pointer to the end of a document is generated. FIGS. 19A and 19B show example of the abstract. FIG. 19A indicates a source document, and FIG. 19B indicates an image of the generated abstract. Note that the position of the reading pointer is set so that the reading pointer is located at the end of the read document (i.e., at the head of an unread part). When a document is read aloud, the position of the reading pointer moves in synchronism with the reading process.

In fast-forward reading pointer backup generation step S1208, corresponding points to which the reading pointer is to be moved upon restoring from the fast-forward mode are generated. In FIGS. 19A and 19B, arrows which connect the abstract and source document are the corresponding points. However, FIGS. 19A and 19B illustrate not all corresponding points for the sake of simplicity.

In fast-forward reading mode setting step S1209, the reading mode is set to be “fast-forward”, and the flow then returns to event acquisition step S1 in FIG. 2.

It is checked in timer mode checking (fast-forward playback) step S1210 if the timer mode is “fast-forward playback”. If the timer mode is “fast-forward playback”, the flow advances to fast-forward recorded audio playback mode setting step S1211; otherwise, the flow jumps to fast-reverse recorded audio playback mode setting step S1212.

In fast-forward recorded audio playback mode setting step S1211, the recorded audio playback mode is set to be “fast-forward”, and the flow returns to event acquisition step S1.

In fast-reverse recorded audio playback mode setting step S1212, the recorded audio playback mode is set to be “fast-reverse”, and the flow then returns to event acquisition step S1 in FIG. 2.

[Respective Processes of “Speech Synthesis”: FIGS. 15A to 15D]

Respective processes of “speech synthesis” will be described below using FIGS. 15A to 15D.

FIGS. 15A to 15D respectively show the processes in “speech synthesis start”, “speech synthesis stop”, “speech synthesis pause”, and “speech synthesis restart” routines.

In synthetic speech output device setting step S1301, the initial setup process (e.g., a setup of a sampling rate and the like) of a synthetic speech output device is executed.

In synthetic speech output device start step S1302, the synthetic speech output device is started up to start a synthetic speech output operation.

In synthetic speech data clear step S1303, synthetic speech data, which is generated and held in synthetic speech data generation step S1005, is cleared.

In synthetic speech output device stop step S1304, the synthetic speech output device is stopped.

In synthetic speech output device pause step S1305, the synthetic speech output device is paused.

In synthetic speech output device restart step S1306, the operation of the synthetic speech output device paused in synthetic speech output device pause step S1305 is restarted.

[Respective Processes of “Recorded Audio Data Playback”: FIGS. 16A to 16D]

Respective processes of “recorded audio data playback” will be described below using FIGS. 16A to 16D. FIGS. 16A to 16D respectively show the processes in “recorded audio data playback start”, “recorded audio data playback stop”, “recorded audio data playback pause”, and “recorded audio data playback restart” routines.

In recorded audio data output device setting step S1401, the initial setup process (e.g., a setup of a sampling rate and the like) of a recorded audio data output device is executed.

In recorded audio data output device start step S1402, the recorded audio data output device is started up to start a recorded audio data output operation.

In recorded audio data output device stop step S1403, the recorded audio data output device is stopped.

In recorded audio data output device pause step S1404, the recorded audio data output device is paused.

In recorded audio data output device restart step S1405, the operation of the recorded audio data output device paused in recorded audio data output device pause step S1404 is restarted.

Note that the first embodiment described above is an example. For example, in first word list generation step S1204, the first word list consists of one word at the head of each sentence. However, the present invention is not limited to one word at the head of a sentence, but a plurality of words set by the user may be used.

The example of the abstract in abstract generation step S1207 is generated by extracting principal parts of respective sentences. However, the abstract need not always be generated for respective sentences, and all sentences with little information may be omitted.

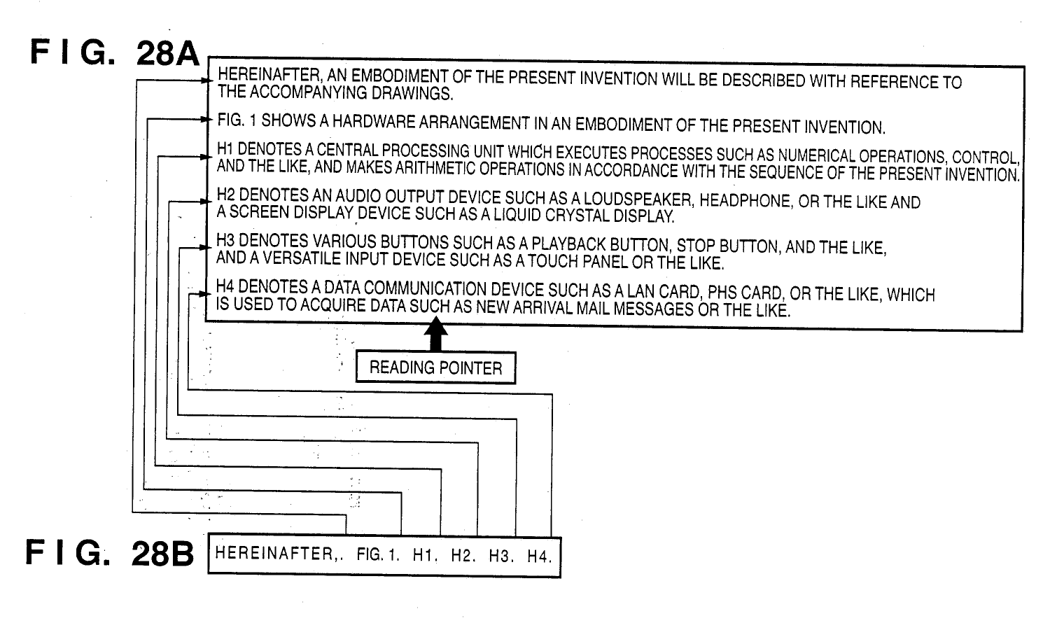

In place of abstract generation step S1207, in the fast-forward mode, a first word list may be generated, as shown in FIGS. 28A and 28B, and words from “hereinafter” at the head of the generated first word list to “H4 denotes” may be read out in turn from the head.

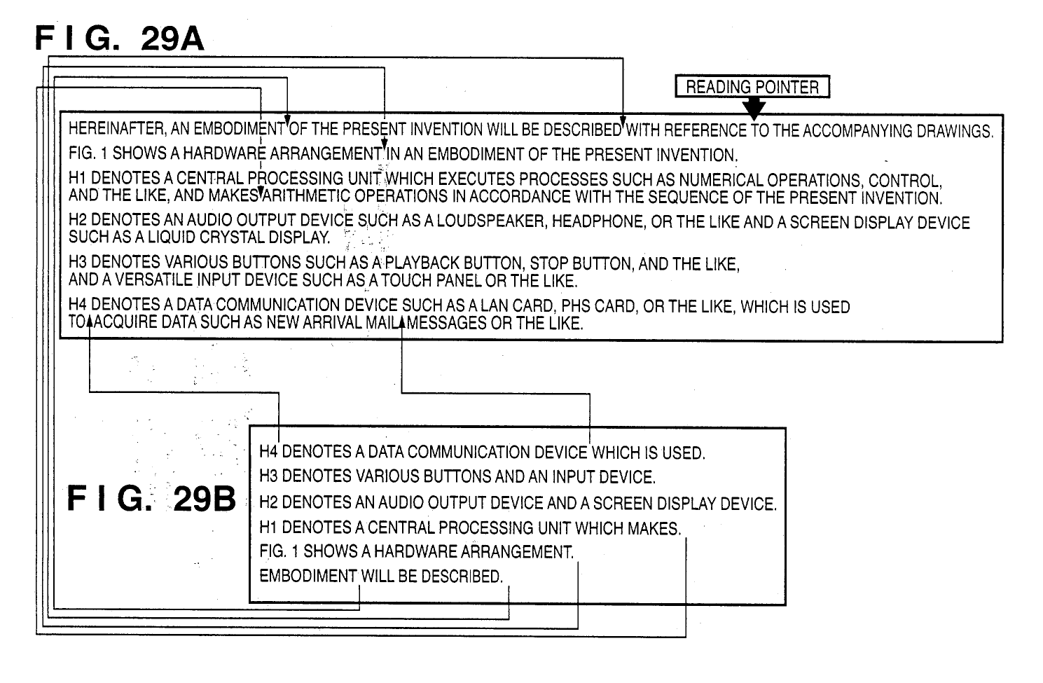

If an abstract is used in the fast-reverse mode, an abstract exemplified in FIGS. 29A and 29B may be used.

Also, an audio output such as a beep tone indicating omission may be output in correspondence with parts which are not read aloud using speech synthesis of the text data.

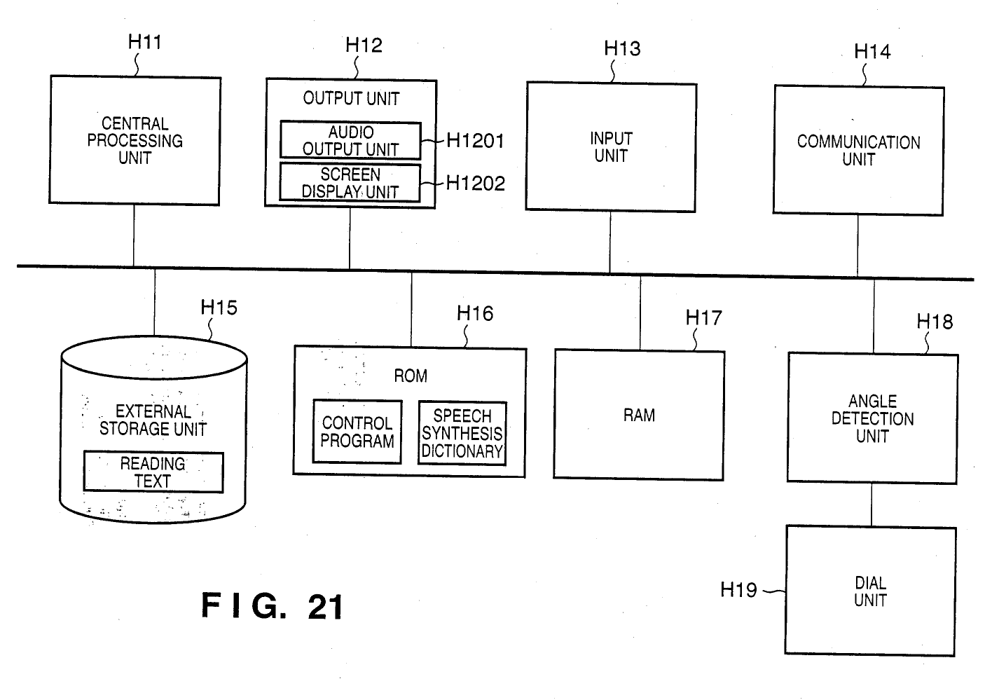

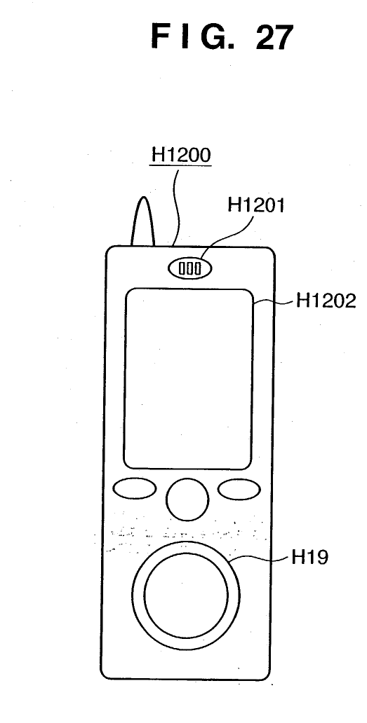

Furthermore, first word list generation step S1204 and abstract generation step S1207 are executed after the release event of the fast-reverse/fast-forward button is acquired, but these steps may be executed after new arrival reading sentence copy step S803, new arrival reading sentence adding step S807, and stored reading sentence copy step S902. In this manner, the response time from release of the fast-reverse/fast-forward button can be shortened.

<Second Embodiment>

[Hardware Arrangement: FIG. 21, FIG. 27]

FIG. 21 is a block diagram showing the hardware arrangement of a portable information terminal H1200 in the second embodiment. FIG. 27 shows an outer appearance of the information terminal H1200.

Reference numeral H11 denotes a central processing unit which executes processes such as numerical operations, control, and the like, and makes arithmetic operations in accordance with a control program that describes the processing sequence of the present invention. Reference numeral H12 denotes an output unit which presents information to the user. The output unit H2 includes an audio output unit H1201 such as a loudspeaker, headphone, or the like, and a screen display unit H1202 such as a liquid crystal display or the like.

Reference numeral H13 denotes an input unit at which the user issues an operation instruction to the information terminal H1200 or inputs information. Reference numeral H14 denotes a data communication unit such as a LAN card, PHS card, or the like, which is used to acquire data such as new arrival mail messages. Reference numeral H15 denotes a storage unit such as a hard disk, nonvolatile memory, or the like, which holds recorded audio data and stored information.

Reference numeral H16 denotes a read-only storage unit which stores the control program that indicates the sequence of the present invention, and permanent data such as a speech synthesis dictionary and the like. Reference numeral H17 denotes a storage unit such as a RAM or the like, which temporarily holds information. The storage unit H7 holds temporary data, various flags, and the like.

Reference numeral H18 denotes an angle detection unit which outputs a value corresponding to an angle, and detects the operation amount of a dial unit H19. Reference numeral H19 denotes a dial unit which can be operated by the user, and is connected to the angle detection unit H18. The central processing unit H1 to angle detection unit H18 are connected via a bus.

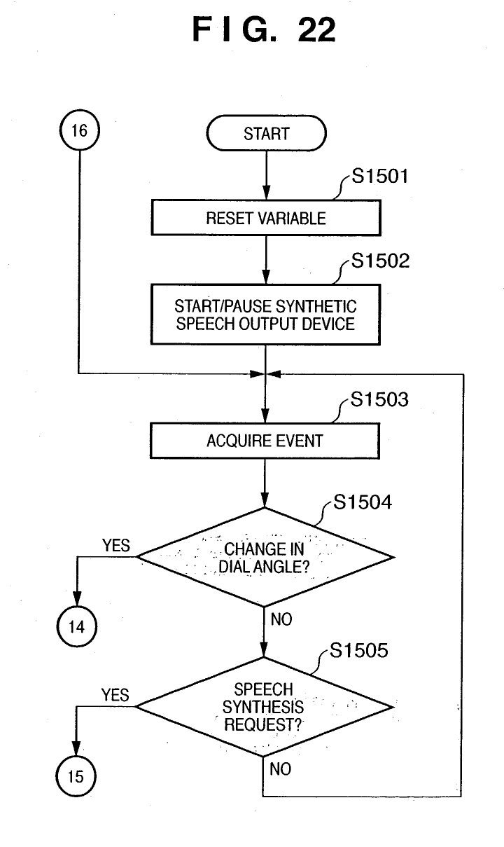

It should be emphasized that although the information terminal illustrated in FIGS. 21 and 27 utilizes a dial unit as a input device, the principles of the present invention are not limited to the dial unit. Rather, the present invention is equally applicable to other input device such as a slide adjusting device. Therefore, the following discussion is provided by way of explanation, and not limitation.

[Outline of Event Process: FIG. 22]

The event process in the aforementioned information terminal H1200 of the second embodiment will be described below using the flow charts shown in FIGS. 22 to 24. Note that the processes to be described below are executed by the central processing unit H11 using the storage unit H17 (RAM or the like) that temporarily stores information on the basis of an event-driven control program stored in the read-only storage unit H16 or the like. An input process from the input unit H13, a data request from the output unit H12, and an interrupt signal such as a timer interrupt signal or the like are processed as instructions that indicate the start of respective events in the control program.

Referring to FIG. 22, respective variables are set to be initial values in variable initial setting step S1501.

In speech synthesis device start/pause step S1502, a speech synthesis device is paused.

In event acquisition step S1503, a new event is acquired.

It is checked in dial angle change checking step S1504 if the event acquired in event acquisition step S1503 is generated in response to a “change in dial angle”. If the acquired event is generated in response to the “change in dial angle”, the flow advances to step S1601; otherwise, the flow advances to speech synthesis data request checking step S1505.

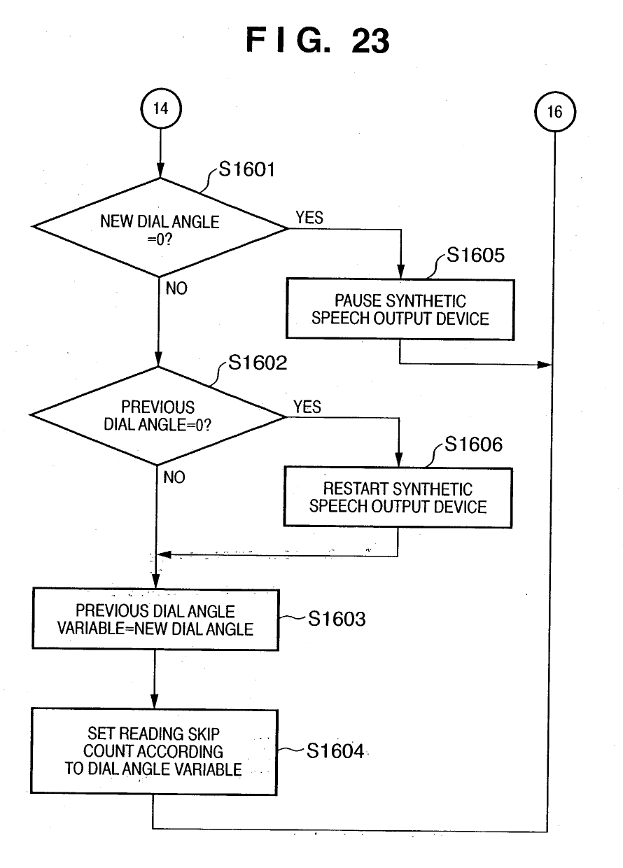

It is checked in speech synthesis data request checking step S1505 if the event acquired in event acquisition step S1503 is a “data request from a synthetic speech output device”. If the acquired event is the “data request from a synthetic speech output device”, the flow advances to step S1701; otherwise, the flow returns to event acquisition step S1503.

[“Dial Angle Change” Process: FIG. 23]

The processes of the aforementioned events will be described in detail hereinafter.

The “dial angle change” process will be described first using FIG. 23.

It is checked in new dial angle checking step S1601 if a new dial angle is “0”. If the new dial angle is “0”, the flow advances to synthetic speech output device pause step S1605; otherwise, the flow advances to dial angle variable checking step S1602.

It is checked in dial angle variable checking step S1602 if the previous dial angle held in a dial angle variable is “0”. If the previous dial angle held in the dial angle variable is “0”, the flow advances to synthetic speech output device restart step S1606; otherwise, the flow advances to dial angle variable update step S1603.

In dial angle variable update step S1603, a new dial angle is substituted in the dial angle variable.

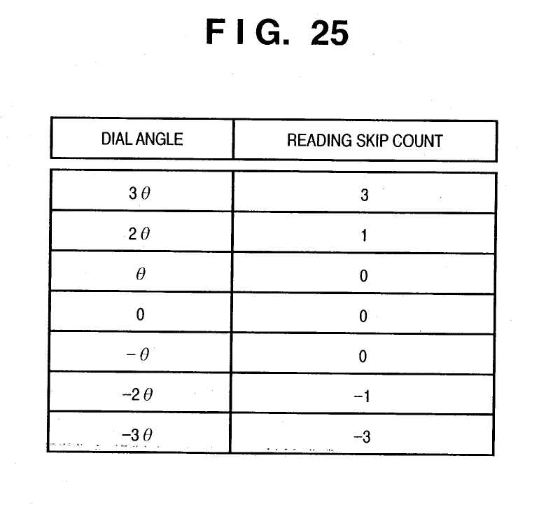

In reading skip count setting step S1604, a reading skip count is set in accordance with the value of the dial angle. The reading skip count is set so that the absolute value of the skip count increases with increasing absolute value of the dial value, and the dial angle and skip count have the same sign. FIG. 25 shows an example of a correspondence table between the dial angle (unit angle=θ) and skip count. After the skip count is set, the flow returns to event acquisition step S1503.

In synthetic speech output device pause step S1605, the synthetic speech output device is paused, and the flow returns to event acquisition step S1503.

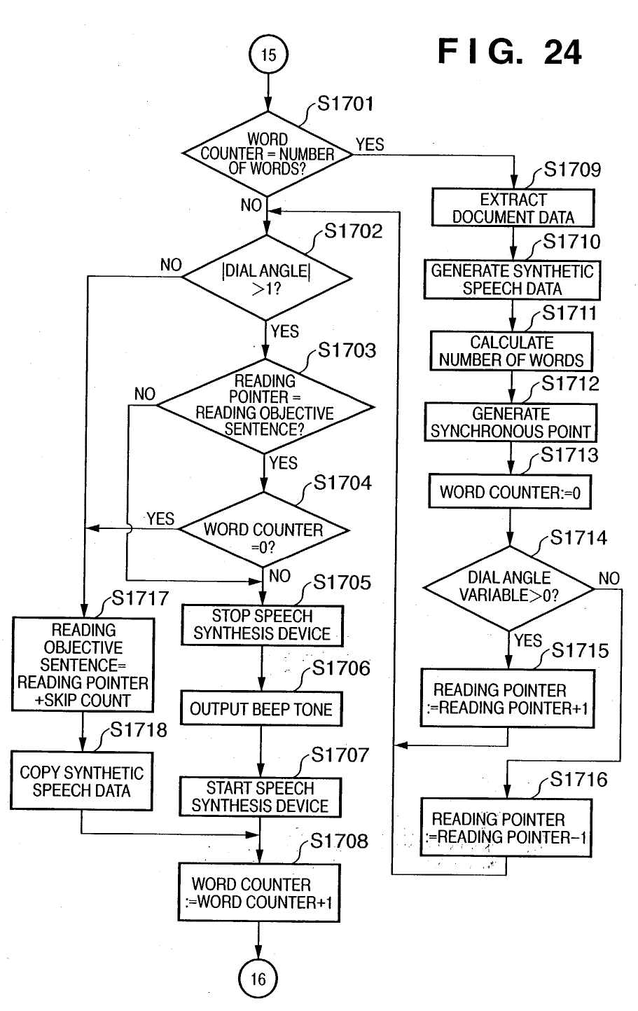

In synthetic speech output device restart step S1606, the synthetic speech output device paused in synthetic speech output device pause step S1605 is restarted, and the flow advances to dial angle variable update step S1603.

[“Speech Synthesis Instruction” Process: FIG. 24]

The “speech synthesis instruction” process will be described below using FIG. 24.

It is checked in synthetic speech data end checking step S1701 if a “word counter is equal to the number of words”. If the “word counter is equal to the number of words”, the flow advances to document data extraction step S1709; otherwise, the flow advances to dial angle absolute value checking step S1702. The number of words is that contained in a sentence which was to be processed in previously executed synthetic speech data generation step S1710, and when the word counter is equal to the number of words, it indicates that synthetic speech data obtained in step S1710 has been output.

It is checked in dial angle absolute value checking step S1702 if the absolute value of the dial angle held in the dial angle variable is larger than “1”. If the absolute value of the dial angle is larger than “1”, the flow advances to reading objective sentence update step S1717; otherwise, the flow advances to reading pointer checking step S1703.

It is checked in reading pointer checking step S1703 if a “reading pointer is equal to a reading objective sentence”. If the “reading pointer is equal to a reading objective sentence”, the flow advances to word counter checking step S1704; otherwise, the flow jumps to speech synthesis device stop step S1705.

It is checked in word counter checking step S1704 if the word counter is “0”. If the word counter is “0”, the flow advances to reading objective sentence update step S1717; otherwise, the flow advances to speech synthesis device stop step S1705.

In speech synthesis device stop step S1705, the speech synthesis device is stopped. In beep tone output step S1706, a beep tone is output. In speech synthesis device start (2) step S1707, the speech synthesis device is started.

In word counter update step S1708, “1” is added to the word counter, and the flow returns to event acquisition step S1503.

In document data extraction step S1709, data for one sentence is extracted from a reading objective document to have the reading pointer as the head position.

In synthetic speech data generation step S1710, the sentence extracted in document data extraction step S1709 undergoes speech synthesis to obtain synthetic speech data.

In word count calculation step S1711, the number of words contained in the sentence extracted in document data extraction step S1709 is calculated.

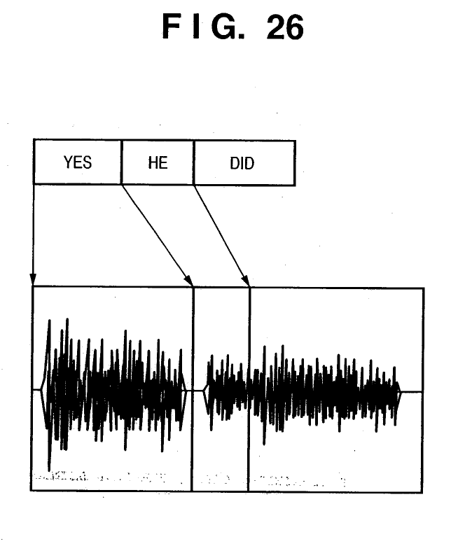

In synchronous point generation step S1712, the correspondence between the synthetic speech generated in synthetic speech data generation step S1710 and the words contained in the sentence extracted in document data extraction step S1709 is obtained, and is held as synchronous points. FIG. 26 shows an example of synchronous points.

In word counter reset step S1713, the word counter is reset to “0”.

It is checked in dial angle sign checking step S1714 if the dial angle held in the dial angle variable has a “positive” sign. If the dial angle is “positive”, the flow advances to reading pointer increment step S1715; otherwise, the flow jumps to reading pointer decrement step S1716.

In reading pointer increment step S1715, the reading pointer is incremented by “1”, and the flow return to dial angle absolute value checking step S1702.

In reading pointer decrement step S1716, the reading pointer is decremented by “1”, and the flow return to dial angle absolute value checking step S1702.

In reading objective sentence update step S1717, a reading objective sentence is set to be the sum of the reading pointer and the skip count set in reading skip count setting step S1604.

In synthetic speech data copy step S1718, data for one word of the synthetic speech generated in synthetic speech data generation step S1710 is copied to a buffer of the speech synthesis device. The copy range corresponds to one word from the synchronous point corresponding to the current word counter. After the data is copied, the flow advances to word counter update step S1708.

Note that the aforementioned second embodiment is an example. For example, in reading skip count setting step S1604, the reading skip count holds a given number of sentences according to the value of the dial angle variable. Alternatively, if the dial angle is large, sentences to be read may be skipped to the next paragraph. Such process can be implemented by counting the number of sentences from the reading pointer to the first sentence of the next paragraph. If the dial angle is small, one or a plurality of words may be skipped.

In the second embodiment, the number of beep tones generated during the fast-forward/fast-reverse process is the same as the number of skipped words, but they need not always be equal to each other. In the second embodiment, the fast-forward/fast-reverse process is expressed using a single beep tone color. Alternatively, different beep tone colors or signals may be produced in accordance with the type of fast-forward/fast-reverse or the dial angle.

Furthermore, the fast-forward process using an abstract used in the first embodiment may be applied to the second embodiment. In this case, the compression ratio of an abstract can be changed in correspondence with the skip count set in reading skip count setting step S1604.

<Third Embodiment>

As described above, since the conventional text-to-speech reading apparatus or software uses a constant return amount of the reading start position upon restarting reading, it rarely helps the user understand the contents of actual sentences.

For the purpose of making the user bring association with the previously read sentence to mind upon restarting reading, the return amount of the reading start position upon restarting reading is an important issue. If the time between the previous reading end timing and the reading restart timing is very short (e.g., several minutes), since the user keeps most of previously read contents in remembrance, the return amount of the reading restart position can be small. However, as the time between the previous reading end timing and the reading restart timing becomes longer, the user forgets more previously read contents, and it becomes harder for the user to bring the previously read contents to mind upon restarting reading. In this case, a larger return amount of the reading restart position helps user's understanding. That is, an optimal return amount of the reading restart position, which makes the user bring the previously read contents to mind, should be adjusted in correspondence with a circumstance associated with the user.

Hence, the present inventors propose that the return amount of the reading restart position upon restarting reading after it is stopped is adjusted in accordance with the time duration between the reading stop and restart timings.

The third embodiment of the present invention will be described in detail hereinafter with reference to the accompanying drawings.

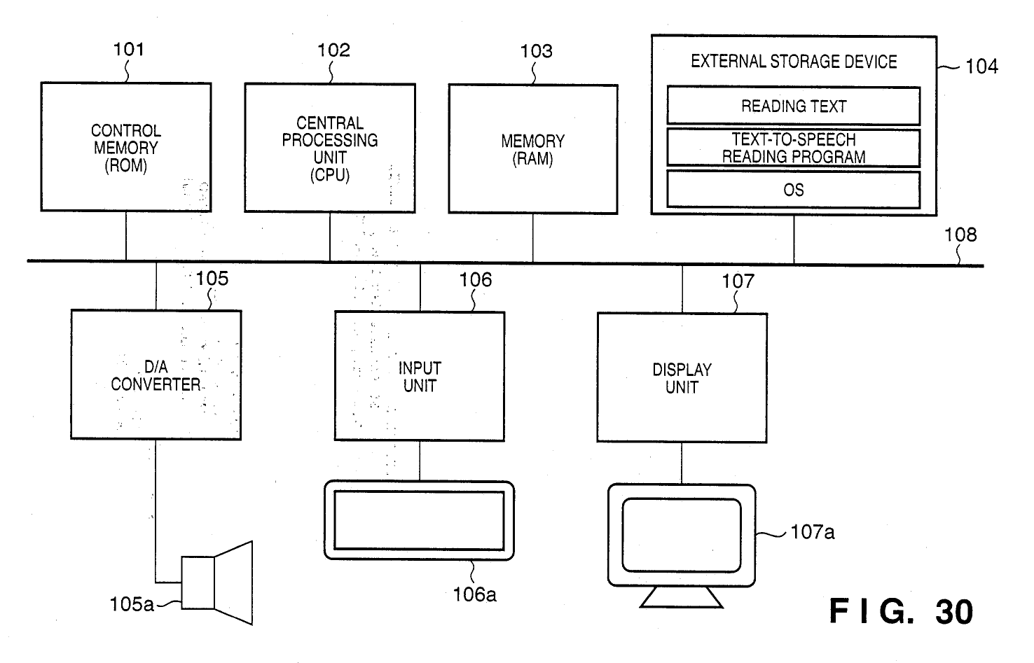

A text-to-speech reading apparatus in this embodiment can be implemented by a versatile personal computer. FIG. 30 is a block diagram showing the hardware arrangement of a personal computer which implements a text-to-speech reading apparatus of this embodiment. This embodiment will explain a case wherein a versatile personal computer using a CPU is used as a text-to-speech reading apparatus, but the present invention may use a dedicated hardware logic without using any CPU.

Referring to FIG. 30, reference numeral 101 denotes a control memory (ROM) which stores a boot program, various control parameters, and the like; 102, a central processing unit (CPU) which controls the overall text-to-speech reading apparatus; and 103, a memory (RAM) serving as a main storage device.

Reference numeral 104 denotes an external storage device (e.g., a hard disk), in which a text-to-speech reading program according to the present invention, which reads text aloud using speech synthesis, and reading text are installed in addition to an OS, as shown in FIG. 30. The reading text may be text which is generated using another application (not shown) or one which is externally loaded via the Internet or the like.

Reference numeral 105 denotes a D/A converter which is connected to a loudspeaker 105a. Reference numeral 106 denotes an input unit which is used to input information using a keyboard 106a as a user interface; and 107, a display unit which displays information using a display 107a as another user interface.

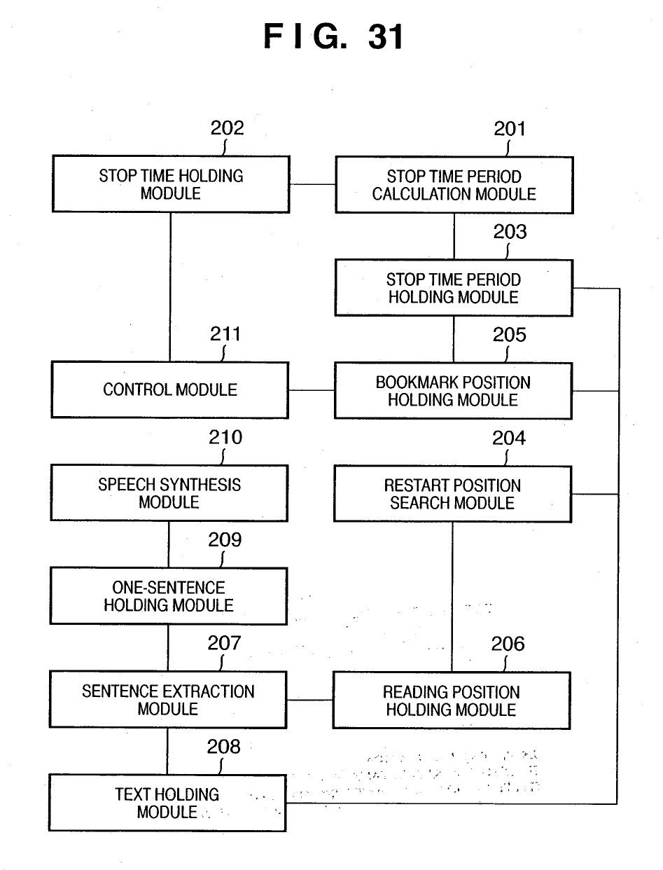

FIG. 31 is a diagram showing the module configuration of the text-to-speech reading program in this embodiment.

A stop time calculation module 201 calculates a time elapsed from the previous reading stop timing until the current timing. A stop time holding module 202 holds a reading stop time in the RAM 103. A stop time period holding module 203 holds a stop time period from the previous reading stop time until reading is restarted in the RAM 103. A restart position search module 204 obtains the reading start position in text. A bookmark position holding module 205 holds position information of text at the time of stop of reading as a bookmark position in the RAM 103. A reading position holding module 206 holds reading start position information in the RAM 103. A sentence extraction module 207 extracts one sentence from text. A text holding module 208 loads and holds reading text stored in the external storage device 104 in the RAM 103. A one-sentence holding module 209 holds the sentence extracted by the sentence extraction module 207 in the RAM 103. A speech synthesis module 210 converts the sentence held by the sentence holding module 209 into speech. A control module 211 monitors a user's reading start/stop instruction on the basis of, e.g., an input at the keyboard 106a.

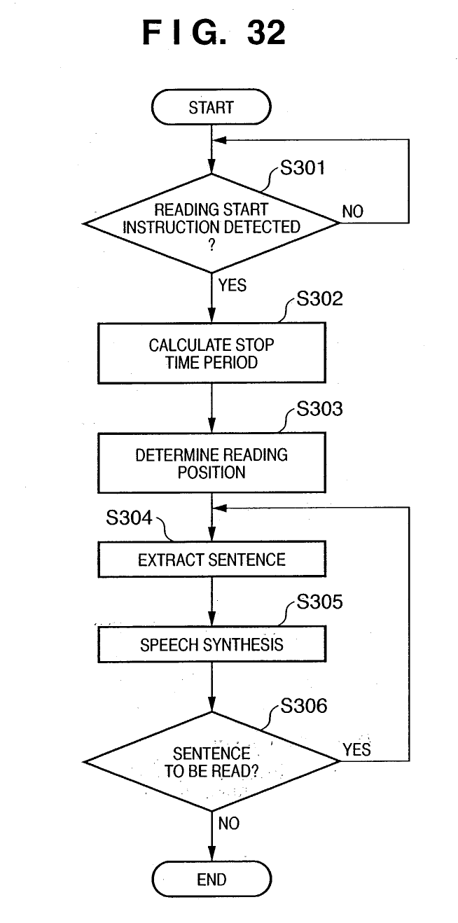

FIG. 32 is a flow chart showing the text-to-speech reading process of the text-to-speech reading apparatus in this embodiment. A program corresponding to this flow chart is contained in the text-to-speech reading program installed in the external storage device 104, is loaded onto the RAM 103, and is executed by the CPU 102.

It is checked in step S3201 on the basis of the monitor result of a user's reading start/stop instruction by the control module 211 if a reading start instruction is detected. If the reading start instruction is detected, the flow advances to step S3202; otherwise, the flow returns to step S3201.

In step S3202, the stop time period calculation module 201 calculates a stop time period on the basis of the previous reading stop time held by the stop time holding module 202 and the current time. The stop time period holding module 203 holds the calculated stop time period in the RAM 103.

In step S3203, the stop time period held by the stop time period holding module 203 (i.e., the stop time period calculated in step S3202), the bookmark position in text held by the bookmark position holding module 205, and text held by the text holding module 208 are input to determine the reading restart position. That is, a position returning a duration corresponding to the stop time period from the bookmark position is determined as the reading restart position. In this case, a sentence is used as a unit of that return amount, and a position that returns the number of sentences proportional to the duration of the stop time period from the bookmark position is determined as the reading restart position.

For example, if the stop time period is less than one hour, the return amount can be set to be one sentence; if the stop time period falls within the range from one hour (inclusive) to two hours (exclusive), two sentences; if the stop time period falls within the range from two hours (inclusive) to three hours (exclusive), three sentences, . . . . In this case, an upper limit may be set. For example, if the stop time period is equal to or longer than 50 hours, the return amount is uniquely set to be 50 sentences.

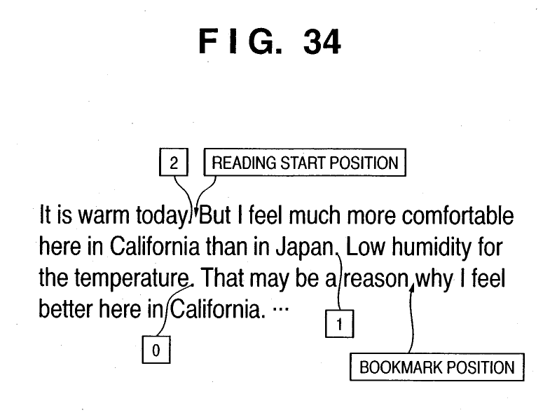

As a simple method of counting the number of sentences, a method of counting the number of periods while retracing text from the bookmark position is available. Also, a character next to the period going back by that number of sentences can be set as the restart position. FIG. 34 shows an example of the search process of the restart position when the number of sentences to go back is 2. As shown in FIG. 34, if the bookmark position is located in the middle of a sentence “That may be a reason why I feel better here in California.”, the text is retraced from that bookmark position until the number of occurrence of “.” becomes 2. In this case, “.” detected first is left out of count. Therefore, the reading start position in this case is the head position of a sentence “But I feel much more comfortable here in California than in Japan.”

In this way, a sentence can be used as a unit of the return amount, but it is merely an example. In place of sentences, the number of paragraphs may be used as a unit. In this case, as a method of counting the number of paragraphs, a position where a period, return code, and space (or TAB code) occur in turn can be determined as a paragraph.

The reading position holding module 206 holds the reading start position determined in step S3203 in the RAM 103.

In step S3204, the sentence extraction module 207 extracts one sentence from reading text held by the text holding module 208 to have the reading position held by the reading position holding module 206 as a start point. The extracted sentence is held by the one-sentence holding module 209. After that, the next extraction position is held by the reading position holding module 206.

In step S3205, the speech synthesis module 210 executes speech synthesis of the sentence held by the one-sentence holding module 209 to read that sentence aloud. It is checked in step S3206 if sentences to be read still remain. If such sentences still remain, the flow returns to step S3204 to repeat the aforementioned process. If no sentences to be read remain, this process ends.

Upon text-to-speech reading using synthetic speech in step S3205, different reading speeds or reading voices (male voice/female voice) may be used upon reading sentences before and after the bookmark position.

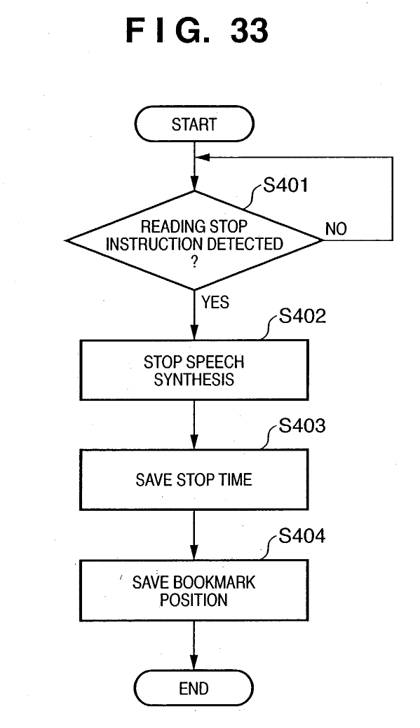

FIG. 33 is a flow chart showing the text-to-speech reading stop process during reading of the text-to-speech reading apparatus of this embodiment. A program corresponding to this flow chart is contained in the text-to-speech reading program installed in the external storage device 104, is loaded onto the RAM 103, and is executed by the CPU 102.

In step S3301, the control module 211 monitors a user's reading stop instruction during reading on the basis of an input at, e.g., the keyboard 106a. Upon detection of the reading stop instruction, the flow advances to step S3302; otherwise, the flow returns to step S3301.

In step S3302, the speech synthesis process of the speech synthesis module 210 is stopped. In step S3303, the stop time holding module 202 holds the current time as a stop time in the RAM 103. Furthermore, in step S3304 the bookmark position holding module 205 holds the text position at the time of stop of reading in the RAM 103, thus ending the process.

As described above, according to the third embodiment, the return amount of the reading restart position upon restarting reading after it is stopped is adjusted in accordance with the time duration between the reading stop and restart timings. In this way, the restart position upon restarting reading after it is stopped can be adjusted to an optimal position that makes the user bring association with the previously read sentences to mind.

<Other Embodiments>

In the aforementioned embodiment, the reading text is English. However, the present invention is not limited to such specific language, but may be applied to other languages such as Japanese, French, and the like. In such cases, punctuation mark detection means corresponding to respective languages such as Japanese, French and the like are prepared.

In the above embodiment, an abstract generation module may be further added as a module of the text-to-speech reading program, and when text is read aloud while retracing text from the bookmark position upon restarting reading, an abstract may be read aloud. In this case, the length of the abstract may be adjusted in accordance with the stop time period.

The adjustment process of the return amount of the reading restart position in the third embodiment can be applied to the speech synthesis function of the information terminal in the first and second embodiments mentioned above.

The text-to-speech reading apparatus in the above embodiment is implemented using one personal computer. However, the present invention is not limited to this, and the aforementioned process may be implemented by collaboration among the modules of the text-to-speech reading program, that are distributed to a plurality of computers and processing apparatuses, which are, in turn, connected via a network.

Alternatively, the present invention may be applied to either a system constituted by a plurality of devices (e.g., a host computer, interface device, reader, printer, and the like), or an apparatus consisting of a single equipment (e.g., a copying machine, facsimile apparatus, or the like).

Note that the present invention includes a case wherein the invention is achieved by directly or remotely supplying a program of software that implements the functions of the aforementioned embodiments to a system or apparatus, and reading out and executing the supplied program code by a computer of that system or apparatus.

Therefore, the program code itself installed in a computer to implement the functional process of the present invention using the computer implements the present invention. That is, the scope of the present invention includes the computer program itself for implementing the functional process of the present invention.

In this case, the form of program is not particularly limited, and an object code, a program to be executed by an interpreter, script data to be supplied to an OS, and the like may be used as along as they have the program function.

As a storage medium for supplying the program, for example, a flexible disk, hard disk, optical disk (CD-ROM, CD-R, CD-RW, DVD, and the like), magnetooptical disk, magnetic tape, memory card, and the like may be used.

As another program supply method, the program of the present invention may be acquired by file transfer via the Internet.

Also, a storage medium such as a CD-ROM or the like, which stores the encrypted program of the present invention, may be delivered to the user, the user who has cleared a predetermined condition may be allowed to acquire key information that decrypts the program via the Internet, and the encrypted program may be executed using that key information to be installed on a computer, thus implementing the present invention.

The functions of the aforementioned embodiments may be implemented not only by executing the readout program code by the computer but also by some or all of actual processing operations executed by an OS or the like running on the computer on the basis of an instruction of that program.

Furthermore, the functions of the aforementioned embodiments may be implemented by some or all of actual processes executed by a CPU or the like arranged in a function extension board or a function extension unit, which is inserted in or connected to the computer, after the program read out from the recording medium is written in a memory of the extension board or unit.

The present invention is not limited to the above embodiments and various changes and modifications can be made within the spirit and scope of the present invention. Therefore, to apprise the public of the scope of the present invention, the following claims are made.

What is claimed is:

1. An information processing apparatus comprising:
playback means for playing back audio data;
speech synthesis means for converting text data into synthetic speech, and outputting the synthetic speech;
instruction detection means for detecting a user's instruction;
detection means for detecting operation states of said playback means and said speech synthesis means;
instruction supply means for supplying the user's instruction to one of said playback means and said speech synthesis means in accordance with the operation states; and
control means for controlling said playback means or said speech synthesis means that has received the user's instruction to execute a process based on the user's instruction.

2. The apparatus according to claim 1, wherein the user's instruction is one of a fast-forward, fast-reverse, stop, and pause instructions.

3. The apparatus according to claim 1, wherein said instruction supply means supplies the instruction to said speech synthesis means when said speech synthesis means is active.

4. The apparatus according to claim 1, wherein said instruction supply means supplies the instruction to said playback means when said speech synthesis means is inactive and said playback means is active.

5. The apparatus according to claim 2, wherein when the user's instruction is a fast-forward instruction and said instruction supply means supplies the instruction to said speech synthesis means, said control means controls said speech synthesis means to generate abstract data by extracting predetermined partial data from respective sentences of text data to be read, and to output the abstract data as synthetic speech.

6. The apparatus according to claim 2, wherein when the user's instruction is a fast-forward instruction and said instruction supply means supplies the instruction to said speech synthesis means, said control means controls said speech synthesis means to extract the first words from respective sentences of text data to be read and to output the extracted words as synthetic speech in turn.

7. The apparatus according to claim 2, wherein when the user's instruction is a fast-reverse instruction and said instruction supply means supplies the instruction to said speech synthesis means, said control means controls said speech synthesis means to extract the first words from respective sentences of text data to be read and to output the extracted words as synthetic speech in an order opposite to an arrangement of sentences of the text data.

8. The apparatus according to claim 1, wherein when the user's instruction is a playback instruction, said instruction supply means detects whether or not a reading pointer indicating a reading start position is set in the text data, and when the reading pointer is detected, said instruction supply means supplies the user's instruction to said speech synthesis means to start speech synthesis of the text data from the position of the reading pointer.

9. The apparatus according to claim 1, wherein when the user's instruction is a playback instruction, said instruction supply means detects whether or not a playback pointer indicating a playback start position is set in recorded audio data, and when the playback pointer is detected, said instruction supply means supplies the user's instruction to said playback means to start playback of the recorded audio data from the position of the playback pointer.

10. The apparatus according to claim 1, wherein said control means controls said speech synthesis means to output a predetermined tone in correspondence with data, of the text data, which does not undergo speech synthesis of said speech synthesis means and is omitted.

11. An information processing apparatus comprising:
speech synthesis means for converting text data into synthetic speech, and outputting the synthetic speech;
input means used to input a user's instruction;
status detection means for detecting a state of the input means; and
control means for controlling said speech synthesis means to output synthetic speech of the text data in a fast-forward mode or a fast-reverse mode in accordance with the detected state of the input means.

12. The apparatus according to claim 11, wherein said input means is a dial, and said status detection means detects an angle of said dial.

13. The apparatus according to claim 12, wherein said control means controls to output synthetic speech of the text data in the fast-forward mode when the angle of said dial is positive.

14. The apparatus according to claim 13, wherein said control means comprises change means for changing the number of words to be skipped, which are to undergo speech synthesis, in the fast-forward mode.

15. The apparatus according to claim 14, wherein said control means controls said speech synthesis means to output a predetermined tone in correspondence with a position of each skipped word.

16. The apparatus according to claim 12, wherein said control means controls to output synthetic speech of the text data in the fast-reverse mode when the angle of said dial is negative.

17. The apparatus according to claim 15, wherein said control means comprises change means for changing the number of words to be skipped, which are to undergo speech synthesis, in the fast-reverse mode.

18. The apparatus according to claim 17, wherein said control means controls said speech synthesis means to output a predetermined tone in correspondence with a position of each skipped word.

19. An information processing method comprising:
a playback step of playing back audio data;
a speech synthesis step of converting text data into synthetic speech, and outputting the synthetic speech;
an instruction detection step of detecting a user's instruction;
a detection step of detecting operation states of the playback step and the speech synthesis step;
an instruction supply step of supplying the user's instruction to one of the playback step and the speech synthesis step in accordance with the operation states; and
a control step of controlling the playback step or the speech synthesis step that has received the user's instruction to execute a process based on the user's instruction.

20. An information processing method comprising:
a speech synthesis step of converting text data into synthetic speech, and outputting the synthetic speech;
a status detection step of detecting a state of a input means used to input a user's instruction; and
a control step of controlling the speech synthesis step to output synthetic speech of the text data in a fast-forward mode or a fast-reverse mode in accordance with the detected state of the input means.

21. A program for making a computer execute:
a playback step of playing back audio data;
a speech synthesis step of converting text data into synthetic speech, and outputting the synthetic speech;
an instruction detection step of detecting a user's instruction;
a detection step of detecting operation states of the playback step and the speech synthesis step;
an instruction supply step of supplying the user's instruction to one of the playback step and the speech synthesis step in accordance with the operation states; and
a control step of controlling the playback step or the speech synthesis step that has received the user's instruction to execute a process based on the user's instruction.

22. A computer readable storage medium that stores a program for making a computer execute:
a playback step of playing back audio data;
a speech synthesis step of converting text data into synthetic speech, and outputting the synthetic speech;
an instruction detection step of detecting a user's instruction;
a detection step of detecting operation states of the playback step and the speech synthesis step;
an instruction supply step of supplying the user's instruction to one of the playback step and the speech synthesis step in accordance with the operation states; and
a control step of controlling the playback step or the speech synthesis step that has received the user's instruction to execute a process based on the user's instruction.

23. A program for controlling an information processing apparatus which has an input means used to input a user's instruction,
said program making a computer execute:
a speech synthesis step of converting text data into synthetic speech, and outputting the synthetic speech;
a status detection step of detecting a state of the input means; and
a control step of controlling the speech synthesis step to output synthetic speech of the text data in a fast-forward mode or a fast-reverse mode in accordance with the detected state of the input means.

24. A computer readable storage medium that stores a control program for controlling an information processing apparatus which has an input means used to input a user's instruction,
said control program making a computer execute:
a speech synthesis step of converting text data into synthetic speech, and outputting the synthetic speech;
a status detection step of detecting a state of the input means; and
a control step of controlling the speech synthesis step to output synthetic speech of the text data in a fast-forward mode or a fast-reverse mode in accordance with the detected state of the input means.

25. An information processing apparatus comprising:
speech synthesis means for converting text data into synthetic speech, and outputting the synthetic speech;
instruction detection means for detecting a user's instruction;
detection means for detecting an operation state of said speech synthesis means;
instruction supply means for supplying the user's instruction to said speech synthesis means in accordance with the operation state; and
control means for controlling said speech synthesis means that has received the user's instruction to execute a process based on the user's instruction.

26. The apparatus according to claim 25, wherein when the user's instruction is a fast-forward instruction and said instruction supply means supplies the instruction to said speech synthesis means, said control means controls said speech synthesis means to generate abstract data by extracting predetermined partial data from respective sentences of text data to be read, and to output the abstract data as synthetic speech.

27. The apparatus according to claim 25, wherein when the user's instruction is a fast-forward instruction and said instruction supply means supplies the instruction to said speech synthesis means, said control means controls said speech synthesis means to extract the first words from respective sentences of text data to be read and to output the extracted words as synthetic speech in turn.

28. The apparatus according to claim 25, wherein when the user's instruction is a fast-reverse instruction and said instruction supply means supplies the instruction to said speech synthesis means, said control means controls said speech synthesis means to extract the first words from respective sentences of text data to be read and to output the extracted words as synthetic speech in an order opposite to an arrangement of sentences of the text data.

29. The apparatus according to claim 25, wherein said control means controls said speech synthesis means to output a predetermined tone in correspondence with data, of the text data, which does not undergo speech synthesis of said speech synthesis means and is omitted.

30. A program for making a computer implement text-to-speech reading using speech synthesis,
said program making the computer execute:
a control step of controlling start/stop of text-to-speech reading of text;
a measurement step of measuring a time period between reading stop and restart timings; and
a determination step of determining a reading restart position of the text upon restarting the text-to-speech reading in accordance with the measured time period.

31. The program according to claim 30, wherein the determination step includes the step of determining a position going back a given number of sentences corresponding to the time period from a position of the text at the reading stop timing as the reading restart position.

32. The program according to claim 31, wherein the number of sentences is counted based on punctuation marks.

33. The program according to claim 30, wherein the determination step includes the step of determining a position going back a given number of paragraphs corresponding to the time period from a position of the text at the reading stop timing as the reading restart position.

34. The program according to claim 33, wherein the number of paragraphs is counted on the basis of positions at each of which a punctuation mark, return code, and space occur in turn.

35. The program according to claim 30, further comprising the step of changing at least one of a reading speed and reading voice before and after a reading position of the text at the reading stop timing.

36. A text-to-speech reading apparatus for implementing text-to-speech reading using speech synthesis, comprising:
control means for controlling start/stop of text-to-speech reading of text; and
measurement means for measuring a time period between reading stop and restart timings,
wherein said control means controls a reading restart position of the text upon restarting the text-to-speech reading in accordance with the measured time period.

37. The apparatus according to claim 36, wherein said control means determines a position going back a given number of sentences corresponding to the time period from a position of the text at the reading stop timing as the reading restart position.

38. The apparatus according to claim 37, wherein the number of sentences is counted based on punctuation marks.

39. The apparatus according to claim 36, wherein said control means determines a position going back a given number of paragraphs corresponding to the time period from a position of the text at the reading stop timing as the reading restart position.

40. The apparatus according to claim 39, wherein the number of paragraphs is counted on the basis of positions at each of which a punctuation mark, return code, and space occur in turn.

41. The apparatus according to claim 36, further comprising means for changing at least one of a reading speed and reading voice before and after a reading position of the text at the reading stop timing.

42. A method of controlling a text-to-speech reading apparatus for implementing text-to-speech reading using speech synthesis, comprising:
a control step of controlling start/stop of text-to-speech reading of text;
a measurement step of measuring a time period between reading stop and restart timings; and
a determination step of determining a reading restart position of the text upon restarting the text-to-speech reading in accordance with the measured time period.
